(19) United States
(12) Patent Application Publication
(10) Pub. No.: US 2024/0255742 A1
(43) Pub. Date: Aug. 1, 2024

(54) VARIABLE MAGNIFICATION OPTICAL SYSTEM, OPTICAL APPARATUS, AND METHOD FOR MANUFACTURING VARIABLE MAGNIFICATION OPTICAL SYSTEM

(71) Applicant: NIKON CORPORATION, Minato-ku, Tokyo (JP)

(72) Inventors: Takuro ONO, Tokyo (JP); Kosuke MACHIDA, Tokyo (JP); Ayumu MAKIDA, Tokyo (JP); Keisuke TSUBONOYA, Tokyo (JP)

(21) Appl. No.: 18/290,407

(22) PCT Filed: Mar. 2, 2022
(86) PCT No.: PCT/JP2022/008978

§ 371 Date: Nov. 13, 2023

(30) Foreign Application Priority Data
Jun. 9, 2021 (JP) 2021-096939

(51) Int. Cl. G02B 15/14; G02B 15/20

(52) U.S. Cl. CPC G02B 15/1461; G02B 15/20

(57) ABSTRACT

A variable magnification optical system including a plurality of lens groups, which is six or more lens groups and comprises a first lens group having positive refractive power and a rear group disposed closer to an image side than the first lens group, is configured so that at varying magnification the distances between the lens groups are varied, the first lens group consists of two or fewer lenses, and both the following conditional expressions are satisfied:

7.50<f1/D1<55.00 (1)

4.00<M1/D1<22.00 (2)

where f1 is the focal length of the first lens group, D1 is the thickness of the first lens group on an optical axis, and M1 is the amount of movement of the first lens group at varying magnification from a wide-angle end state to a telephoto end state.

### TECHNICAL FIELD

The present disclosure relates to a variable magnification optical system, an optical apparatus, and a method for manufacturing a variable magnification optical system.

### BACKGROUND ART

Variable magnification optical systems used in optical apparatuses, such as cameras for photographs, electronic still cameras, and video cameras, have been proposed (see, e.g., PTL 1).

### CITATION LIST

### Patent Literature

[PTL 1]

Japanese Unexamined Patent Publication No. 2020-170102

### SUMMARY OF INVENTION

A variable magnification optical system of the present disclosure includes a plurality of lens groups; the plurality of lens groups is six or more lens groups and comprises a first lens group having positive refractive power and a rear group disposed closer to an image side than the first lens group; at varying magnification the distances between the lens groups are varied; the first lens group consists of two or fewer lenses; both the following conditional expressions are satisfied:

7.50<f1/D1<55.00

4.00<M1/D1<22.00

where
f1 is the focal length of the first lens group,
D1 is the thickness of the first lens group on an optical axis, and
M1 is the amount of movement of the first lens group at varying magnification from a wide-angle end state to a telephoto end state.

A method for manufacturing a variable magnification optical system of the present disclosure is a method for manufacturing a variable magnification optical system including a plurality of lens groups; the plurality of lens groups is six or more lens groups and comprises a first lens group having positive refractive power and a rear group disposed closer to an image side than the first lens group; the method includes arranging so that at varying magnification the distances between the lens groups are varied, the first lens group consists of two or more lenses, and both the following conditional expressions are satisfied:

7.50<f1/D1<55.00

4.00<M1/D1<22.00

where
f1 is the focal length of the first lens group,
D1 is the thickness of the first lens group on an optical axis, and
M1 is the amount of movement of the first lens group at varying magnification from a wide-angle end state to a telephoto end state.

### BRIEF DESCRIPTION OF DRAWINGS

FIG. 1 is a cross-sectional view of a variable magnification optical system of a first example focusing on an object at infinity in the wide-angle end state.

FIG. 2A shows aberrations of the variable magnification optical system of the first example focusing on an object at infinity in the wide-angle end state.

FIG. 2B shows aberrations of the variable magnification optical system of the first example focusing on an object at infinity in an intermediate focal length state.

FIG. 2C shows aberrations of the variable magnification optical system of the first example focusing on an object at infinity in the telephoto end state.

FIG. 3 is a cross-sectional view of a variable magnification optical system of a second example focusing on an object at infinity in the wide-angle end state.

FIG. 4A shows aberrations of the variable magnification optical system of the second example focusing on an object at infinity in the wide-angle end state.

FIG. 4B shows aberrations of the variable magnification optical system of the second example focusing on an object at infinity in an intermediate focal length state.

FIG. 4C shows aberrations of the variable magnification optical system of the second example focusing on an object at infinity in the telephoto end state.

FIG. 5 is a cross-sectional view of a variable magnification optical system of a third example focusing on an object at infinity in the wide-angle end state.

FIG. 6A shows aberrations of the variable magnification optical system of the third example focusing on an object at infinity in the wide-angle end state.

FIG. 6B shows aberrations of the variable magnification optical system of the third example focusing on an object at infinity in an intermediate focal length state.

FIG. 6C shows aberrations of the variable magnification optical system of the third example focusing on an object at infinity in the telephoto end state.

FIG. 7 is a cross-sectional view of a variable magnification optical system of a fourth example focusing on an object at infinity in the wide-angle end state.

FIG. 8A shows aberrations of the variable magnification optical system of the fourth example focusing on an object at infinity in the wide-angle end state.

FIG. 8B shows aberrations of the variable magnification optical system of the fourth example focusing on an object at infinity in an intermediate focal length state.

FIG. 8C shows aberrations of the variable magnification optical system of the fourth example focusing on an object at infinity in the telephoto end state.

FIG. 9 is a cross-sectional view of a variable magnification optical system of a fifth example focusing on an object at infinity in the wide-angle end state.

FIG. 10A shows aberrations of the variable magnification optical system of the fifth example focusing on an object at infinity in the wide-angle end state.

FIG. 10B shows aberrations of the variable magnification optical system of the fifth example focusing on an object at infinity in an intermediate focal length state.

FIG. 10C shows aberrations of the variable magnification optical system of the fifth example focusing on an object at infinity in the telephoto end state.

FIG. 11 is a cross-sectional view of a variable magnification optical system of a sixth example focusing on an object at infinity in the wide-angle end state.

FIG. 12A shows aberrations of the variable magnification optical system of the sixth example focusing on an object at infinity in the wide-angle end state.

FIG. 12B shows aberrations of the variable magnification optical system of the sixth example focusing on an object at infinity in an intermediate focal length state.

FIG. 12C shows aberrations of the variable magnification optical system of the sixth example focusing on an object at infinity in the telephoto end state.

FIG. 13 is a cross-sectional view of a variable magnification optical system of a seventh example focusing on an object at infinity in the wide-angle end state.

FIG. 14A shows aberrations of the variable magnification optical system of the seventh example focusing on an object at infinity in the wide-angle end state.

FIG. 14B shows aberrations of the variable magnification optical system of the seventh example focusing on an object at infinity in an intermediate focal length state.

FIG. 14C shows aberrations of the variable magnification optical system of the seventh example focusing on an object at infinity in the telephoto end state.

FIG. 15 is a cross-sectional view of a variable magnification optical system of an eighth example focusing on an object at infinity in the wide-angle end state.

FIG. 16A shows aberrations of the variable magnification optical system of the eighth example focusing on an object at infinity in the wide-angle end state.

FIG. 16B shows aberrations of the variable magnification optical system of the eighth example focusing on an object at infinity in an intermediate focal length state.

FIG. 16C shows aberrations of the variable magnification optical system of the eighth example focusing on an object at infinity in the telephoto end state.

FIG. 17 is a cross-sectional view of a variable magnification optical system of a ninth example focusing on an object at infinity in the wide-angle end state.

FIG. 18A shows aberrations of the variable magnification optical system of the ninth example focusing on an object at infinity in the wide-angle end state.

FIG. 18B shows aberrations of the variable magnification optical system of the ninth example focusing on an object at infinity in an intermediate focal length state.

FIG. 18C shows aberrations of the variable magnification optical system of the ninth example focusing on an object at infinity in the telephoto end state.

FIG. 19 schematically shows a camera including a variable magnification optical system of the embodiment.

FIG. 20 is a flowchart outlining a method for manufacturing a variable magnification optical system of the embodiment.

### DESCRIPTION OF EMBODIMENTS

The following describes a variable magnification optical system, an optical apparatus, and a method for manufacturing a variable magnification optical system of an embodiment of the present application.

A variable magnification optical system of the present embodiment includes a plurality of lens groups; the plurality of lens groups is six or more lens groups and comprises a first lens group having positive refractive power and a rear group disposed closer to an image side than the first lens group; at varying magnification the distances between the lens groups are varied; the first lens group consists of two or fewer lenses; both the following conditional expressions are satisfied:

7.50<f1/D1<55.00 (1)

4.00<M1/D1<22.00 (2)

where
f1 is the focal length of the first lens group,
D1 is the thickness of the first lens group on an optical axis, and
M1 is the amount of movement of the first lens group at varying magnification from a wide-angle end state to a telephoto end state.

The variable magnification optical system of the present embodiment can be reduced in weight by including two or fewer lenses in the first lens group.

Conditional expression (1) restricts the ratio of the focal length of the first lens group to the thickness of the first lens group on an optical axis. The variable magnification optical system of the present embodiment, which satisfies conditional expression (1), can appropriately reduce variations in aberrations including spherical aberration at varying magnification.

If the value of conditional expression (1) is greater than the upper limit in the variable magnification optical system of the present embodiment, the first lens group will be too thin on the optical axis, making it difficult to appropriately reduce variations in aberrations including spherical aberration at varying magnification.

The effect of the present embodiment can be ensured by setting the upper limit of conditional expression (1) to 55.00 in the variable magnification optical system of the present embodiment. To further ensure the effect of the present embodiment, the upper limit of conditional expression (1) is preferably set to 54.50, 54.00, 50.00, 45.00, 40.00, 35.00, 30.00, or 17.50, more preferably to 15.00.

If the value of conditional expression (1) is less than the lower limit in the variable magnification optical system of the present embodiment, the first lens group will have too strong refractive power, making it difficult to appropriately reduce variations in aberrations including spherical aberration at varying magnification.

The effect of the present embodiment can be ensured by setting the lower limit of conditional expression (1) to 7.50 in the variable magnification optical system of the present embodiment. To further ensure the effect of the present embodiment, the lower limit of conditional expression (1) is preferably set to 8.00, 8.25, 8.50, or 8.75, more preferably to 9.00.

Conditional expression (2) restricts the ratio of the amount of movement of the first lens group at varying magnification from a wide-angle end state to a telephoto end state to the thickness of the first lens group on an optical axis. The variable magnification optical system of the present embodiment, which satisfies conditional expression (2), can appropriately reduce variations in aberrations including spherical aberration at varying magnification.

If the value of conditional expression (2) is greater than the upper limit in the variable magnification optical system of the present embodiment, the first lens group will be too thin on the optical axis, making it difficult to appropriately reduce variations in aberrations including spherical aberration at varying magnification.

The effect of the present embodiment can be ensured by setting the upper limit of conditional expression (2) to 22.00 in the variable magnification optical system of the present embodiment. To further ensure the effect of the present embodiment, the upper limit of conditional expression (2) is preferably set to 21.00, 20.00, 17.50, 15.00, 12.50, 10.00, 8.50, or 7.50, more preferably to 6.50.

If the value of conditional expression (2) is less than the lower limit in the variable magnification optical system of the present embodiment, the amount of movement of the first lens group will be too large, making it difficult to appropriately reduce variations in aberrations including spherical aberration at varying magnification.

The effect of the present embodiment can be ensured by setting the lower limit of conditional expression (2) to 4.00 in the variable magnification optical system of the present embodiment. To further ensure the effect of the present embodiment, the lower limit of conditional expression (2) is preferably set to 4.25, 4.50, 4.75, 4.85, 5.00, or 5.10, more preferably to 5.25.

A variable magnification optical system satisfying both conditional expressions (1) and (2) can appropriately reduce variations in aberrations including spherical aberration at varying magnification.

In the variable magnification optical system of the present embodiment, the rear group preferably includes a first negative lens group having negative refractive power, and the following conditional expression is preferably satisfied:

2.50<f1/(−fN1)<7.00 (3)

where
fN1 is the focal length of the first negative lens group.

Conditional expression (3) restricts the ratio of the focal length of the first lens group to that of the first negative lens group. The variable magnification optical system of the present embodiment, which satisfies conditional expression (3), can appropriately reduce variations in aberrations including spherical aberration at varying magnification.

If the value of conditional expression (3) is greater than the upper limit in the variable magnification optical system of the present embodiment, the first negative lens group will have too strong refractive power, making it difficult to appropriately reduce variations in aberrations including spherical aberration at varying magnification.

The effect of the present embodiment can be ensured by setting the upper limit of conditional expression (3) to 7.00 in the variable magnification optical system of the present embodiment. To further ensure the effect of the present embodiment, the upper limit of conditional expression (3) is preferably set to 6.90, 6.75, 6.60, or 6.40, more preferably to 6.00.

If the value of conditional expression (3) is less than the lower limit in the variable magnification optical system of the present embodiment, the first lens group will have too strong refractive power, making it difficult to appropriately reduce variations in aberrations including spherical aberration at varying magnification.

The effect of the present embodiment can be ensured by setting the lower limit of conditional expression (3) to 2.50 in the variable magnification optical system of the present embodiment. To further ensure the effect of the present embodiment, the lower limit of conditional expression (3) is preferably set to 2.60, 2.75, 2.90, 3.00, or 3.10, more preferably to 3.20.

In the variable magnification optical system of the present embodiment, the rear group preferably includes a first negative lens group having negative refractive power, and a second negative lens group having negative refractive power and disposed closer to the image side than the first negative lens group, and the following expression is preferably satisfied:

0.05<f1/(−fN2)<6.50 (4)

where
fN2 is the focal length of the second negative lens group.

Conditional expression (4) restricts the ratio of the focal length of the first lens group to that of the second negative lens group. The variable magnification optical system of the present embodiment, which satisfies conditional expression (4), can appropriately reduce variations in aberrations including spherical aberration at varying magnification.

If the value of conditional expression (4) is greater than the upper limit in the variable magnification optical system of the present embodiment, the second negative lens group will have too strong refractive power, making it difficult to appropriately reduce variations in aberrations including spherical aberration at varying magnification.

The effect of the present embodiment can be ensured by setting the upper limit of conditional expression (4) to 6.50 in the variable magnification optical system of the present embodiment. To further ensure the effect of the present embodiment, the upper limit of conditional expression (4) is preferably set to 6.40, 6.30, 6.25, 6.20, 6.10, or 6.00, more preferably to 5.90.

If the value of conditional expression (4) is less than the lower limit in the variable magnification optical system of the present embodiment, the first lens group will have too strong refractive power, making it difficult to appropriately reduce variations in aberrations including spherical aberration at varying magnification.

The effect of the present embodiment can be ensured by setting the lower limit of conditional expression (4) to 0.05 in the variable magnification optical system of the present embodiment. To further ensure the effect of the present embodiment, the lower limit of conditional expression (4) is preferably set to 0.08, 0.10, 0.15, 0.25, 0.50, 0.75, 0.90, or 1.00, more preferably to 1.25.

In the variable magnification optical system of the present embodiment, the rear group preferably includes a first negative lens group having negative refractive power, and a second negative lens group having negative refractive power and disposed closer to the image side than the first negative lens group, and the following expression is preferably satisfied:

0.01<fN1/fN2<1.20 (5)

where
fN1 is the focal length of the first negative lens group, and
fN2 is the focal length of the second negative lens group.

Conditional expression (5) restricts the ratio of the focal length of the first negative lens group to that of the second negative lens group. The variable magnification optical system of the present embodiment, which satisfies conditional expression (5), can appropriately reduce variations in aberrations including spherical aberration at varying magnification.

If the value of conditional expression (5) is greater than the upper limit in the variable magnification optical system of the present embodiment, the second negative lens group will have too strong refractive power, making it difficult to appropriately reduce variations in aberrations including spherical aberration at varying magnification.

The effect of the present embodiment can be ensured by setting the upper limit of conditional expression (5) to 1.20 in the variable magnification optical system of the present embodiment. To further ensure the effect of the present embodiment, the upper limit of conditional expression (5) is preferably set to 1.10, 1.00, 0.95, 0.90, 0.80, 0.70, or 0.50, more preferably to 0.45.

If the value of conditional expression (5) is less than the lower limit in the variable magnification optical system of the present embodiment, the first negative lens group will have too strong refractive power, making it difficult to appropriately reduce variations in aberrations including spherical aberration at varying magnification.

The effect of the present embodiment can be ensured by setting the lower limit of conditional expression (5) to 0.01 in the variable magnification optical system of the present embodiment. To further ensure the effect of the present embodiment, the lower limit of conditional expression (5) is preferably set to 0.05, 0.10, 0.30, or 0.50, more preferably to 0.75.

In the variable magnification optical system of the present embodiment, the first negative lens group is preferably a lens group disposed closest to an object side of lens groups having negative refractive power in the rear group.

The variable magnification optical system of the present embodiment having such a configuration can appropriately reduce variations in aberrations including spherical aberration at varying magnification.

In the variable magnification optical system of the present embodiment, the rear group preferably includes a first positive lens group having positive refractive power, and the following conditional expression is preferably satisfied:

1.00<f1/fP1<5.00 (6)

where
fP1 is the focal length of the first positive lens group.

Conditional expression (6) restricts the ratio of the focal length of the first lens group to that of the first positive lens group. The variable magnification optical system of the present embodiment, which satisfies conditional expression (6), can appropriately reduce variations in aberrations including spherical aberration at varying magnification.

If the value of conditional expression (6) is greater than the upper limit in the variable magnification optical system of the present embodiment, the first positive lens group will have too strong refractive power, making it difficult to appropriately reduce variations in aberrations including spherical aberration at varying magnification.

The effect of the present embodiment can be ensured by setting the upper limit of conditional expression (6) to 5.00 in the variable magnification optical system of the present embodiment. To further ensure the effect of the present embodiment, the upper limit of conditional expression (6) is preferably set to 4.90, 4.80, 4.75, 4.70, 4.50, 4.25, 4.00, or 3.50, more preferably to 3.00.

If the value of conditional expression (6) is less than the lower limit in the variable magnification optical system of the present embodiment, the first lens group will have too strong refractive power, making it difficult to appropriately reduce variations in aberrations including spherical aberration at varying magnification.

The effect of the present embodiment can be ensured by setting the lower limit of conditional expression (6) to 1.00 in the variable magnification optical system of the present embodiment. To further ensure the effect of the present embodiment, the lower limit of conditional expression (6) is preferably set to 1.10, 1.25, 1.40, or 1.50, more preferably to 1.75.

In the variable magnification optical system of the present embodiment, the rear group preferably includes a first positive lens group having positive refractive power, and a first negative lens group having negative refractive power and disposed closer to the image side than the first positive lens group, and the following conditional expression is preferably satisfied:

0.40<fP1/(−fN1)<5.50 (7)

where
fP1 is the focal length of the first positive lens group, and
fN1 is the focal length of the first negative lens group.

Conditional expression (7) restricts the ratio of the focal length of the first positive lens group to that of the first negative lens group. The variable magnification optical system of the present embodiment, which satisfies conditional expression (7), can appropriately reduce variations in aberrations including spherical aberration at varying magnification.

If the value of conditional expression (7) is greater than the upper limit in the variable magnification optical system of the present embodiment, the first negative lens group will have too strong refractive power, making it difficult to appropriately reduce variations in aberrations including spherical aberration at varying magnification.

The effect of the present embodiment can be ensured by setting the upper limit of conditional expression (7) to 5.50 in the variable magnification optical system of the present embodiment. To further ensure the effect of the present embodiment, the upper limit of conditional expression (7) is preferably set to 5.40, 5.25, 5.10, 5.00, 4.85, 4.70, 4.50, or 4.00, more preferably to 3.75.

If the value of conditional expression (7) is less than the lower limit in the variable magnification optical system of the present embodiment, the first positive lens group will have too strong refractive power, making it difficult to appropriately reduce variations in aberrations including spherical aberration at varying magnification.

The effect of the present embodiment can be ensured by setting the lower limit of conditional expression (7) to 0.40 in the variable magnification optical system of the present embodiment. To further ensure the effect of the present embodiment, the lower limit of conditional expression (7) is preferably set to 0.35, 0.50, 0.55, 0.60, 0.65, 0.70, 1.00, or 1.25, more preferably to 1.50.

In the variable magnification optical system of the present embodiment, the rear group preferably includes a first positive lens group having positive refractive power, and a second positive lens group having positive refractive power and disposed closer to the image side than the first positive lens group.

The variable magnification optical system of the present embodiment having such a configuration can appropriately reduce variations in aberrations including spherical aberration at varying magnification.

The variable magnification optical system of the present embodiment preferably satisfies the following conditional expression:

0.20<fP1/fP2<5.50 (8)

where
fP1 is the focal length of the first positive lens group, and
fP2 is the focal length of the second positive lens group.

Conditional expression (8) restricts the ratio of the focal length of the first positive lens group to that of the second positive lens group. The variable magnification optical system of the present embodiment, which satisfies conditional expression (8), can appropriately reduce variations in aberrations including spherical aberration at varying magnification.

If the value of conditional expression (8) is greater than the upper limit in the variable magnification optical system of the present embodiment, the second positive lens group will have too strong refractive power, making it difficult to appropriately reduce variations in aberrations including spherical aberration at varying magnification.

The effect of the present embodiment can be ensured by setting the upper limit of conditional expression (8) to 5.50 in the variable magnification optical system of the present embodiment. To further ensure the effect of the present embodiment, the upper limit of conditional expression (8) is preferably set to 5.40, 5.25, 5.10, 5.00, 4.95, 4.90, 4.00, or 3.50, more preferably to 3.00.

If the value of conditional expression (8) is less than the lower limit in the variable magnification optical system of the present embodiment, the first positive lens group will have too strong refractive power, making it difficult to appropriately reduce variations in aberrations including spherical aberration at varying magnification.

The effect of the present embodiment can be ensured by setting the lower limit of conditional expression (8) to 0.20 in the variable magnification optical system of the present embodiment. To further ensure the effect of the present embodiment, the lower limit of conditional expression (8) is preferably set to 0.25, 0.30, 0.35, 0.38, or 0.50, more preferably to 0.60.

In the variable magnification optical system of the present embodiment, the first positive lens group is preferably a lens group disposed closest to an object side of lens groups having positive refractive power in the rear group.

The variable magnification optical system of the present embodiment having such a configuration can appropriately reduce variations in aberrations including spherical aberration at varying magnification.

In the variable magnification optical system of the present embodiment, the rear group preferably includes a positive focusing group having positive refractive power and configured to move along the optical axis at focusing, and the following conditional expression is preferably satisfied:

1.00<f1/fFP<5.00 (9)

where
fFP is the focal length of the positive focusing group.

Conditional expression (9) restricts the ratio of the focal length of the first lens group to that of the positive focusing group. The variable magnification optical system of the present embodiment, which satisfies conditional expression (9), can appropriately reduce variations in aberrations including spherical aberration at focusing and at varying magnification.

If the value of conditional expression (9) is greater than the upper limit in the variable magnification optical system of the present embodiment, the positive focusing group will have too strong refractive power, making it difficult to appropriately reduce variations in aberrations including spherical aberration at focusing.

The effect of the present embodiment can be ensured by setting the upper limit of conditional expression (9) to 5.00 in the variable magnification optical system of the present embodiment. To further ensure the effect of the present embodiment, the upper limit of conditional expression (9) is preferably set to 4.90, 4.75, 4.60, 4.50, 4.40, 4.25, 4.15, 4.00, 3.75, 3.50, 3.25, or 3.00, more preferably to 2.75.

If the value of conditional expression (9) is less than the lower limit in the variable magnification optical system of the present embodiment, the first lens group will have too strong refractive power, making it difficult to appropriately reduce variations in aberrations including spherical aberration at varying magnification.

The effect of the present embodiment can be ensured by setting the lower limit of conditional expression (9) to 1.00 in the variable magnification optical system of the present embodiment. To further ensure the effect of the present embodiment, the lower limit of conditional expression (9) is preferably set to 1.10, 1.25, or 1.40, more preferably to 1.50.

In the variable magnification optical system of the present embodiment, the rear group preferably includes a positive focusing group having positive refractive power and configured to move along the optical axis at focusing, and the following conditional expression is preferably satisfied:

−3.50<fFP/fRPw<1.00 (10)

where
fFP is the focal length of the positive focusing group, and
fRPw is a combined focal length in the wide-angle end state of one or more lens groups disposed closer to the image side than the positive focusing group.

Conditional expression (10) restricts the ratio of the focal length of the positive focusing group to a combined focal length in the wide-angle end state of the lens groups disposed closer to the image side than the positive focusing group. The variable magnification optical system of the present embodiment, which satisfies conditional expression (10), can appropriately reduce aberrations including coma aberration in the wide-angle end state and appropriately reduce variations in aberrations including spherical aberration at focusing.

If the value of conditional expression (10) is greater than the upper limit in the variable magnification optical system of the present embodiment, the lens groups disposed closer to the image side than the positive focusing group will have too strong refractive power in the wide-angle end state, making it difficult to appropriately reduce aberrations including coma aberration in the wide-angle end state.

The effect of the present embodiment can be ensured by setting the upper limit of conditional expression (10) to 1.00 in the variable magnification optical system of the present embodiment. To further ensure the effect of the present embodiment, the upper limit of conditional expression (11) is preferably set to 0.90, 0.80, 0.70, 0.60, 0.50, or 0.40, more preferably to 0.30.

If the value of conditional expression (10) is less than the lower limit in the variable magnification optical system of the present embodiment, the positive focusing group will have too strong refractive power, making it difficult to appropriately reduce variations in aberrations including spherical aberration at focusing.

The effect of the present embodiment can be ensured by setting the lower limit of conditional expression (10) to −3.50 in the variable magnification optical system of the present embodiment. To further ensure the effect of the present embodiment, the lower limit of conditional expression (11) is preferably set to −3.25, −3.15, −3.00, −2.75, −2.50, −2.25, −2.15, or −2.00, more preferably to −1.50.

In the variable magnification optical system of the present embodiment, the rear group preferably includes a negative focusing group having negative refractive power and configured to move along the optical axis at focusing, and the following conditional expression is preferably satisfied:

0.05<f1/(−fFN)<6.50 (11)

where
fFN is the focal length of the negative focusing group.

Conditional expression (11) restricts the ratio of the focal length of the first lens group to that of the negative focusing group. The variable magnification optical system of the present embodiment, which satisfies conditional expression (11), can appropriately reduce variations in aberrations including spherical aberration at focusing and at varying magnification.

If the value of conditional expression (11) is greater than the upper limit in the variable magnification optical system of the present embodiment, the negative focusing group will have too strong refractive power, making it difficult to appropriately reduce variations in aberrations including spherical aberration at focusing.

The effect of the present embodiment can be ensured by setting the upper limit of conditional expression (11) to 6.50 in the variable magnification optical system of the present embodiment. To further ensure the effect of the present embodiment, the upper limit of conditional expression (11) is preferably set to 6.35, 6.20, 6.00, 5.75, 5.50, 5.25, 5.00, 4.50, 4.00, or 3.75, more preferably to 3.50.

If the value of conditional expression (11) is less than the lower limit in the variable magnification optical system of the present embodiment, the first lens group will have too strong refractive power, making it difficult to appropriately reduce variations in aberrations including spherical aberration at varying magnification.

The effect of the present embodiment can be ensured by setting the lower limit of conditional expression (11) to 0.05 in the variable magnification optical system of the present embodiment. To further ensure the effect of the present embodiment, the lower limit of conditional expression (11) is preferably set to 0.10, 0.50, 1.00, 1.20, 1.50, or 1.75, more preferably to 2.00.

In the variable magnification optical system of the present embodiment, the rear group preferably includes a negative focusing group having negative refractive power and configured to move along the optical axis at focusing, and the following conditional expression is preferably satisfied:

−35.00<(−fFN)/fRNw<1.50 (12)

where
fFN is the focal length of the negative focusing group, and
fRNw is a combined focal length in the wide-angle end state of one or more lens groups disposed closer to the image side than the negative focusing group.

Conditional expression (12) restricts the ratio of the focal length of the negative focusing group to the focal length in the wide-angle end state of the lens groups disposed closer to the image side than the negative focusing group. The variable magnification optical system of the present embodiment, which satisfies conditional expression (12), can appropriately reduce aberrations including coma aberration in the wide-angle end state and appropriately reduce variations in aberrations including spherical aberration at focusing.

If the value of conditional expression (12) is greater than the upper limit in the variable magnification optical system of the present embodiment, the lens groups disposed closer to the image side than the negative focusing group will have too strong refractive power in the wide-angle end state, making it difficult to appropriately reduce aberrations including coma aberration in the wide-angle end state.

The effect of the present embodiment can be ensured by setting the upper limit of conditional expression (12) to 1.50 in the variable magnification optical system of the present embodiment. To further ensure the effect of the present embodiment, the upper limit of conditional expression (12) is preferably set to 1.40, 1.25, 1.10, 1.00, or 0.90, more preferably to 0.75.

If the value of conditional expression (12) is less than the lower limit in the variable magnification optical system of the present embodiment, the negative focusing group will have too strong refractive power, making it difficult to appropriately reduce variations in aberrations including spherical aberration at focusing.

The effect of the present embodiment can be ensured by setting the lower limit of conditional expression (12) to −35.00 in the variable magnification optical system of the present embodiment. To further ensure the effect of the present embodiment, the lower limit of conditional expression (12) is preferably set to −32.50, −30.00, −27.50, −25.50, −20.00, −15.00, −10.00, −7.50, −5.00, or −2.50, more preferably to −1.00.

In the variable magnification optical system of the present embodiment, a final lens group disposed closest to the image side of lens groups in the rear group preferably has negative refractive power, and the following conditional expression is preferably satisfied:

0.50<f1/(−fR)<6.50 (13)

where
fR is the focal length of the final lens group.

Conditional expression (13) restricts the ratio of the focal length of the first lens group to that of the final lens group. The variable magnification optical system of the present embodiment, which satisfies conditional expression (13), can appropriately reduce variations in aberrations including spherical aberration at varying magnification.

If the value of conditional expression (13) is greater than the upper limit in the variable magnification optical system of the present embodiment, the final lens group will have too strong refractive power, making it difficult to appropriately reduce variations in aberrations including coma aberration at varying magnification.

The effect of the present embodiment can be ensured by setting the upper limit of conditional expression (13) to 10.00 in the variable magnification optical system of the present embodiment. To further ensure the effect of the present embodiment, the upper limit of conditional expression (13) is preferably set to 9.50, 9.00, 8.75, 7.50, or 6.00, more preferably to 5.00.

If the value of conditional expression (13) is less than the lower limit in the variable magnification optical system of the present embodiment, the first lens group will have too strong refractive power, making it difficult to appropriately reduce variations in aberrations including spherical aberration at varying magnification.

The effect of the present embodiment can be ensured by setting the lower limit of conditional expression (13) to 0.50 in the variable magnification optical system of the present embodiment. To further ensure the effect of the present embodiment, the lower limit of conditional expression (13) is preferably set to 0.65, 0.75, 1.00, 2.00, or 3.00, more preferably to 4.00.

In the variable magnification optical system of the present embodiment, a final lens group disposed closest to the image side of lens groups in the rear group preferably has positive refractive power, and the following conditional expression is preferably satisfied:

0.01<f1/fR<3.00 (14)

where
fR is the focal length of the final lens group.

Conditional expression (14) restricts the ratio of the focal length of the first lens group to that of the final lens group. The variable magnification optical system of the present embodiment, which satisfies conditional expression (14), can appropriately reduce variations in aberrations including spherical aberration at varying magnification.

If the value of conditional expression (14) is greater than the upper limit in the variable magnification optical system of the present embodiment, the final lens group will have too strong refractive power, making it difficult to appropriately reduce variations in aberrations including coma aberration at varying magnification.

The effect of the present embodiment can be ensured by setting the upper limit of conditional expression (14) to 3.00 in the variable magnification optical system of the present embodiment. To further ensure the effect of the present embodiment, the upper limit of conditional expression (14) is preferably set to 2.90, 2.75, 2.50, or 2.25, more preferably to 2.10.

If the value of conditional expression (14) is less than the lower limit in the variable magnification optical system of the present embodiment, the first lens group will have too strong refractive power, making it difficult to appropriately reduce variations in aberrations including spherical aberration at varying magnification.

The effect of the present embodiment can be ensured by setting the lower limit of conditional expression (14) to 0.01 in the variable magnification optical system of the present embodiment. To further ensure the effect of the present embodiment, the lower limit of conditional expression (14) is preferably set to 0.02, 0.10, or 0.20, more preferably to 0.30.

In the variable magnification optical system of the present embodiment, the first lens group preferably includes at least one lens satisfying both the following conditional expressions:

1.45<nd1<2.10 (15)

20.00<vd1<75.00 (16)

where
nd1 is the refractive index for d-line of the lens in the first lens group, and
vd1 is the Abbe number for d-line of the lens in the first lens group.

Conditional expression (15) restricts the refractive index for d-line of the lens in the first lens group, and conditional expression (16) the Abbe number for d-line of the lens in the first lens group. The variable magnification optical system of the present embodiment can favorably correct chromatic aberration and aberrations including spherical aberration in the telephoto end state by including at least one lens satisfying both conditional expressions (15) and (16) in the first lens group.

If the value of conditional expression (15) is greater than the upper limit in the variable magnification optical system of the present embodiment, the final lens group will have too strong refractive power, making it difficult to appropriately reduce variations in aberrations including coma aberration at varying magnification.

The effect of the present embodiment can be ensured by setting the upper limit of conditional expression (15) to 2.10 in the variable magnification optical system of the present embodiment. To further ensure the effect of the present embodiment, the upper limit of conditional expression (16) is preferably set to 2.00, 1.95, 1.90, or 1.85, more preferably to 1.80.

If the value of conditional expression (15) is less than the lower limit in the variable magnification optical system of the present embodiment, the lens in the first lens group will have too weak refractive power, making it difficult to favorably correct aberrations including spherical aberration in the telephoto end state.

The effect of the present embodiment can be ensured by setting the lower limit of conditional expression (15) to 1.45 in the variable magnification optical system of the present embodiment. To further ensure the effect of the present embodiment, the lower limit of conditional expression (15) is preferably set to 1.47 or 1.50, more preferably to 1.55.

If the value of conditional expression (16) is greater than the upper limit in the variable magnification optical system of the present embodiment, the dispersion of the lens in the first lens group will be too small, making it difficult to favorably correct chromatic aberration in the telephoto end state.

The effect of the present embodiment can be ensured by setting the upper limit of conditional expression (16) to 83.00 in the variable magnification optical system of the present embodiment. To further ensure the effect of the present embodiment, the upper limit of conditional expression (16) is preferably set to 82.00, 77.50, 75.00, or 72.50, more preferably to 70.00.

If the value of conditional expression (16) is less than the lower limit in the variable magnification optical system of the present embodiment, the dispersion of the lens in the first lens group will be too small, making it difficult to favorably correct chromatic aberration in the telephoto end state.

The effect of the present embodiment can be ensured by setting the lower limit of conditional expression (16) to 20.00 in the variable magnification optical system of the present embodiment. To further ensure the effect of the present embodiment, the lower limit of conditional expression (16) is preferably set to 25.00, 27.50, 30.00, or 32.50, more preferably to 34.00.

The variable magnification optical system of the present embodiment preferably satisfies the following conditional expression:

0.10<Bfw/fw<0.95 (17)

where
Bfw is the back focus of the variable magnification optical system in the wide-angle end state, and
fw is the focal length of the variable magnification optical system in the wide-angle end state.

Conditional expression (17) restricts the ratio of the back focus of the variable magnification optical system in the wide-angle end state to the focal length of the variable magnification optical system in the wide-angle end state. The variable magnification optical system of the present embodiment, which satisfies conditional expression (17), can be avoided upsizing and favorably correct aberrations including coma aberration in the wide-angle end state.

If the value of conditional expression (17) is greater than the upper limit in the variable magnification optical system of the present embodiment, the back focus will be too long, making it difficult to avoid the optical system upsizing.

The effect of the present embodiment can be ensured by setting the upper limit of conditional expression (17) to 0.95 in the variable magnification optical system of the present embodiment. To further ensure the effect of the present embodiment, the upper limit of conditional expression (17) is preferably set to 0.90, 0.85, 0.80, 0.75, 0.70, 0.65, or 0.60, more preferably to 0.55.

If the value of conditional expression (17) is less than the lower limit in the variable magnification optical system of the present embodiment, the position of an exit pupil will be too close to an image plane, making it difficult to favorably correct aberrations including coma aberration in the wide-angle end state.

The effect of the present embodiment can be ensured by setting the lower limit of conditional expression (17) to 0.10 in the variable magnification optical system of the present embodiment. To further ensure the effect of the present embodiment, the lower limit of conditional expression (17) is preferably set to 0.15, 0.20, 0.25, or 0.30, more preferably to 0.35.

In the variable magnification optical system of the present embodiment, the first lens group preferably moves toward an object side at varying magnification from the wide-angle end state to the telephoto end state.

The variable magnification optical system of the present embodiment having such a configuration can be downsized and appropriately reduce variations in aberrations including spherical aberration at varying magnification.

In the variable magnification optical system of the present embodiment, the first lens group preferably consists of, in order from an object side, a negative lens and a positive lens.

The variable magnification optical system of the present embodiment having such a configuration can be reduced in weight and favorably correct aberrations including spherical aberration in the telephoto end state.

In the variable magnification optical system of the present embodiment, the first lens group preferably consists of a positive lens.

The variable magnification optical system of the present embodiment having such a configuration can be reduced in weight and favorably correct aberrations including spherical aberration in the telephoto end state.

In the variable magnification optical system of the present embodiment, the rear group preferably includes a first focusing group and a second focusing group that move along the optical axis at focusing.

The variable magnification optical system of the present embodiment having such a configuration can appropriately reduce variations in aberrations including spherical aberration at focusing.

The variable magnification optical system of the present embodiment preferably satisfies the following conditional expression:

0.20<|fF1|/|fF2|<30.00 (18)

where
fF1 is the focal length of the first focusing group, and
fF2 is the focal length of the second focusing group.

Conditional expression (18) restricts the ratio of the focal length of the first focusing group to that of the second focusing group. The variable magnification optical system of the present embodiment, which satisfies conditional expression (18), can appropriately reduce variations in aberrations including spherical aberration at focusing.

If the value of conditional expression (18) is greater than the upper limit in the variable magnification optical system of the present embodiment, the second focusing group will have too strong refractive power, making it difficult to appropriately reduce variations in aberrations including spherical aberration at focusing.

The effect of the present embodiment can be ensured by setting the upper limit of conditional expression (18) to 30.00 in the variable magnification optical system of the present embodiment. To further ensure the effect of the present embodiment, the upper limit of conditional expression (18) is preferably set to 27.00, 25.00, 10.00, 2.00, 1.95, 1.90, 1.85, or 1.80, more preferably to 1.75.

If the value of conditional expression (18) is less than the lower limit in the variable magnification optical system of the present embodiment, the first focusing group will have too strong refractive power, making it difficult to appropriately reduce variations in aberrations including spherical aberration at varying magnification.

The effect of the present embodiment can be ensured by setting the lower limit of conditional expression (18) to 0.20 in the variable magnification optical system of the present embodiment. To further ensure the effect of the present embodiment, the lower limit of conditional expression (18) is preferably set to 0.25, 0.30, 0.35, 0.40, or 0.45, more preferably to 0.50.

In the variable magnification optical system of the present embodiment, at least one positive lens in the rear group preferably satisfies the following first conditional expression for dispersion:

vdP1<45.00 (19)

where
vdP1 is the Abbe number for d-line of the positive lens in the rear group.

First conditional expression (19) for dispersion restricts the Abbe number for d-line of the positive lens in the rear group. The variable magnification optical system of the present embodiment can correct chromatic aberration favorably by including a positive lens satisfying first conditional expression (19) for dispersion in the rear group.

The effect of the present embodiment can be ensured by setting the upper limit of first conditional expression (19) for dispersion to 45.00 in the variable magnification optical system of the present embodiment. To further ensure the effect of the present embodiment, the upper limit of first conditional expression (19) for dispersion is preferably set to 43.00, 40.00, 35.00, or 30.00, more preferably to 28.50.

In the variable magnification optical system of the present embodiment, the positive lens satisfying first conditional expression (19) for dispersion is preferably included in a negative lens group having negative refractive power of lens groups in the rear group.

The variable magnification optical system of the present embodiment having such a configuration can correct chromatic aberration more favorably.

In the variable magnification optical system of the present embodiment, at least one negative lens in the rear group preferably satisfies the following second conditional expression for dispersion:

60.00<vdN (20)

where
vdN is the Abbe number for d-line of the negative lens in the rear group.

Second conditional expression (20) for dispersion restricts the Abbe number for d-line of the negative lens in the rear group. The variable magnification optical system of the present embodiment can correct chromatic aberration favorably by including a negative lens satisfying second conditional expression (20) for dispersion.

The effect of the present embodiment can be ensured by setting the lower limit of second conditional expression (20) for dispersion to 60.00 in the variable magnification optical system of the present embodiment. To further ensure the effect of the present embodiment, the lower limit of second conditional expression (20) for dispersion is preferably set to 62.50, 65.00, or 67.50, more preferably to 75.00.

In the variable magnification optical system of the present embodiment, the negative lens satisfying second conditional expression (20) for dispersion is preferably included in a final lens group disposed closest to the image side of lens groups in the rear group.

The variable magnification optical system of the present embodiment having such a configuration can correct chromatic aberration more favorably.

In the variable magnification optical system of the present embodiment, at least one lens group having positive refractive power of lens groups in the rear group preferably includes a positive lens satisfying the following third conditional expression for dispersion:

60.00<vdP2 (21)

where
vdP2 is the Abbe number for d-line of the positive lens in the rear group.

Third conditional expression (21) for dispersion restricts the Abbe number for d-line of the positive lens in the rear group. The variable magnification optical system of the present embodiment can correct chromatic aberration favorably by including a positive lens satisfying third conditional expression (21) for dispersion in the lens groups having positive refractive power.

The effect of the present embodiment can be ensured by setting the lower limit of third conditional expression (21) for dispersion to 60.00 in the variable magnification optical system of the present embodiment. To further ensure the effect of the present embodiment, the lower limit of third conditional expression (21) for dispersion is preferably set to 62.50, 65.00, or 67.50, more preferably to 75.00.

A small-sized variable magnification optical system of favorable imaging performance can be achieved by the above configurations.

An optical apparatus of the present embodiment includes a variable magnification optical system having a configuration described above. This enables achieving an optical apparatus of favorable optical performance.

A method for manufacturing a variable magnification optical system of the present embodiment is a method for manufacturing a variable magnification optical system including a plurality of lens groups; the plurality of lens groups is six or more lens groups and comprises a first lens group having positive refractive power and a rear group disposed closer to an image side than the first lens group; the method includes arranging so that at varying magnification the distances between the lens groups are varied, the first lens group consists of two or more lenses, and all of the following conditional expressions are satisfied:

7.50<f1/D1<55.00 (1)

4.00<M1/D1<22.00 (2)

where
f1 is the focal length of the first lens group,
D1 is the thickness of the first lens group on an optical axis, and
M1 is the amount of movement of the first lens group at varying magnification from a wide-angle end state to a telephoto end state.

A variable magnification optical system of favorable optical performance can be manufactured by such a method for manufacturing a variable magnification optical system.

### NUMERICAL EXAMPLES

Examples of the present application will be described below with reference to the drawings.

### First Example

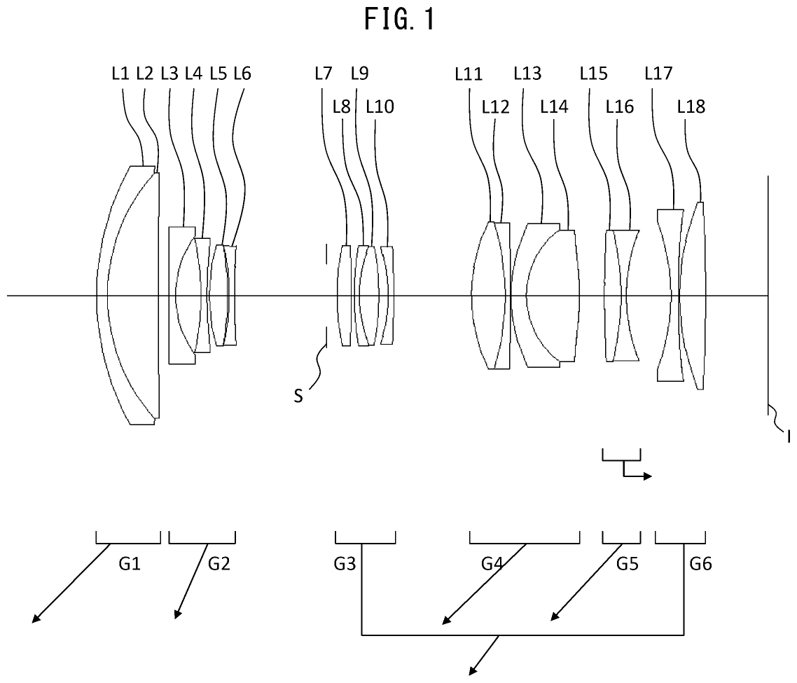

FIG. 1 is a cross-sectional view of a variable magnification optical system of a first example focusing on an object at infinity in the wide-angle end state.

The variable magnification optical system of the present example includes, in order from the object side, a first lens group G1 having positive refractive power, a second lens group G2 having negative refractive power, an aperture stop S, a third lens group G3 having positive refractive power, a fourth lens group G4 having positive refractive power, a fifth lens group G5 having negative refractive power, and a sixth lens group G6 having negative refractive power.

The first lens group G1 consists of a positive cemented lens composed of, in order from the object side, a negative meniscus lens L1 convex on the object side and a positive meniscus lens L2 convex on the object side.

The second lens group G2 consists of, in order from the object side, a negative meniscus lens L3 convex on the object side, a biconcave negative lens L4, a biconvex positive lens L5, and a biconcave negative lens L6.

The third lens group G3 consists of, in order from the object side, a biconvex positive lens L7, a positive cemented lens composed of a negative meniscus lens L8 convex on the object side and a biconvex positive lens L9, and a negative meniscus lens L10 concave on the object side.

The fourth lens group G4 consists of, in order from the object side, a positive cemented lens composed of a biconvex positive lens L11 and a negative meniscus lens L12 concave on the object side as well as a positive cemented lens composed of a negative meniscus lens L13 convex on the object side and a biconvex positive lens L14.

The fifth lens group G5 consists of a negative cemented lens composed of, in order from the object side, a biconvex positive lens L15 and a biconcave negative lens L16.

The sixth lens group G6 consists of, in order from the object side, a biconcave negative lens L17 and a biconvex positive lens L18.

An imaging device (not shown) constructed from CCD, CMOS, or the like is disposed on an image plane I.

The variable magnification optical system of the present example focuses by moving the fifth lens group G5 along the optical axis. When focus is shifted from infinity to a nearby object, the fifth lens group G5 moves from the object side toward the image side.

In the variable magnification optical system of the present example, the second lens group G2, the third lens group G3, the fourth lens group G4, the fifth lens group G5, and the sixth lens group G6 correspond to the rear group, and the sixth lens group G6 to the final lens group. The second lens group G2 corresponds to the first negative lens group, the third lens group G3 to the first positive lens group, the fourth lens group G4 to the second positive lens group, and the fifth lens group G5 to the second negative lens group. The fifth lens group G5 corresponds to the negative focusing group.

Table 8 below shows specifications of the variable magnification optical system of the present example.

In Table 1, fw denotes the focal length of the variable magnification optical system in the wide-angle end state, ft the focal length of the variable magnification optical system in the telephoto end state, Fnow the f-number of the variable magnification optical system in the wide-angle end state, and Fnot the f-number of the variable magnification optical system in the wide-angle end state. TL denotes the total optical length of the variable magnification optical system focusing on an object at infinity in the wide-angle end state, and Bf the back focus of the variable magnification optical system.

In Table 1, m denotes the places of optical surfaces counted from the object side, r the radii of curvature, d the surface-to-surface distances, nd the refractive indices for d-line (wavelength 587.6 nm), and vd the Abbe numbers for d-line. The radius of curvature r-∞ means a plane. In [Lens specifications], the optical surfaces with “*” are aspherical surfaces. [Lens specifications] also shows lenses corresponding to the positive lens P1, the negative lens N, and the positive lens P2 regarding conditional expressions (19), (20), and (21), respectively.

In Table 1, m denotes the optical surfaces corresponding to aspherical surface data, K the conic constants, and A4 to A14 the aspherical coefficients.

The aspherical surfaces are expressed by expression (a) below, where y denotes the height in a direction perpendicular to the optical axis, S(y) the distance along the optical axis from the tangent plane at the vertex of an aspherical surface to the aspherical surface at height y (a sag), r the radius of curvature of a reference sphere (paraxial radius of curvature), K the conic constant, and An the nth-order aspherical coefficient. In the examples, the second-order aspherical coefficient A2 is 0. “E-n” means “×10⁻¹¹.”

$$S ( y ) = ( {y}^{2} / r ) / \{ 1 + {( 1 ‐ K \times {y}^{2} / {r}^{2} )}^{1 / 2} \} + A 4 \times {y}^{4} + A 6 \times {y}^{6} + A 8 \times {y}^{8} + A 10 \times {y}^{10} + A 12 \times {y}^{12} + A 14 \times {y}^{14} \qquad ( a )$$

The unit of the focal lengths fw and ft, the radii of curvature r, and the other lengths listed in Table 1 is “mm.” However, the unit is not limited thereto because the optical performance of a proportionally enlarged or reduced variable magnification optical system is the same as that of the original optical system.

The above reference symbols in Table 1 will also be used similarly in the tables of the other examples described below.

TABLE 1
[General specifications]

| | |
|---|---|
| fw | 24.75 |
| ft | 193.60 |
| Fnow | 4.00 |
| Fnot | 6.50 |

[Lens specifications]

| m | r | d | nd | νd | (19) | (21) |
|---|---|---|---|---|---|---|
| 1) | 50.215 | 2.000 | 1.903660 | 31.27 | | |
| 2) | 34.572 | 9.588 | 1.603000 | 65.44 | | |
| 3) | 1311.519 | d3 | | | | |
| 4) | 734.769 | 1.307 | 1.953750 | 32.33 | | |
| 5) | 18.756 | 4.799 | | | | |
| 6) | −48.834 | 1.129 | 1.755000 | 52.33 | | |
| 7) | 82.569 | 0.451 | | | | |
| 8) | 35.539 | 3.409 | 1.922860 | 20.88 | P1 | |
| 9) | −55.882 | 0.297 | | | | |
| 10) | −40.429 | 1.015 | 1.816000 | 46.59 | | |
| 11) | 149.588 | d11 | | | | |
| 12> | ∞ | 2.016 | (aperture stop) | | | |
| 13) | 45.792 | 2.740 | 1.902650 | 35.72 | P1 | |
| 14) | −158.052 | 0.500 | | | | |
| 15) | 51.626 | 1.000 | 2.001000 | 29.12 | | |
| 16) | 25.348 | 3.645 | 1.579570 | 53.74 | | |
| 17) | −47.120 | 1.756 | | | | |
| 18) | −28.990 | 1.043 | 1.953750 | 32.33 | | |
| 19) | −180.881 | d19 | | | | |
| 20) | 31.325 | 6.348 | 1.834810 | 42.73 | P1 | |
| 21) | −46.677 | 1.000 | 1.903660 | 31.27 | | |
| 22) | −434.420 | 0.175 | | | | |
| 23) | 31.122 | 2.824 | 1.953750 | 32.33 | | |
| 24) | 15.393 | 10.000 | 1.497100 | 81.49 | | P2 |
| *25) | −46.610 | d25 | | | | |
| 26) | 192.398 | 3.146 | 1.846660 | 23.80 | P1 | |
| 27) | −50.784 | 1.017 | 1.851350 | 40.13 | | |
| *28) | 33.031 | d28 | | | | |
| 29) | −39.648 | 1.400 | 1.820800 | 42.51 | | |
| *30) | 237.062 | 0.232 | | | | |
| 31) | 46.735 | 4.880 | 1.683760 | 37.57 | P1 | |
| 32) | −359.761 | Bf | | | | |

[Aspherical surface data]

| m | K | A4 | A6 | A8 | A10 | A12 |
|---|---|---|---|---|---|---|
| 25) | 0.0000 | 3.31E−05 | −5.07E−08 | 7.86E−10 | −4.83E−12 | 1.35E−14 |
| 28) | 0.0000 | −3.68E−06 | 5.73E−08 | −1.75E−10 | −8.02E−13 | 5.32E−15 |
| 30) | 0.0000 | 7.67E−06 | −1.25E−08 | 6.72E−11 | −1.62E−13 | |

[Focal length data of groups]

| Groups | Starting surfaces | Focal lengths |
|---|---|---|
| G1 | 1 | 110.64 |
| G2 | 4 | −16.88 |
| G3 | 13 | 59.63 |
| G4 | 20 | 27.13 |
| G5 | 26 | −47.14 |
| G6 | 29 | −137.34 |

[Variable distance data]

| | Wide-angle end state | Telephoto end state |
|---|---|---|
| d3 | 1.969 | 54.765 |
| d11 | 17.288 | 1.166 |
| d19 | 14.645 | 1.478 |
| d25 | 4.685 | 2.612 |
| d28 | 8.395 | 23.634 |
| Bf | 11.793 | 37.548 |

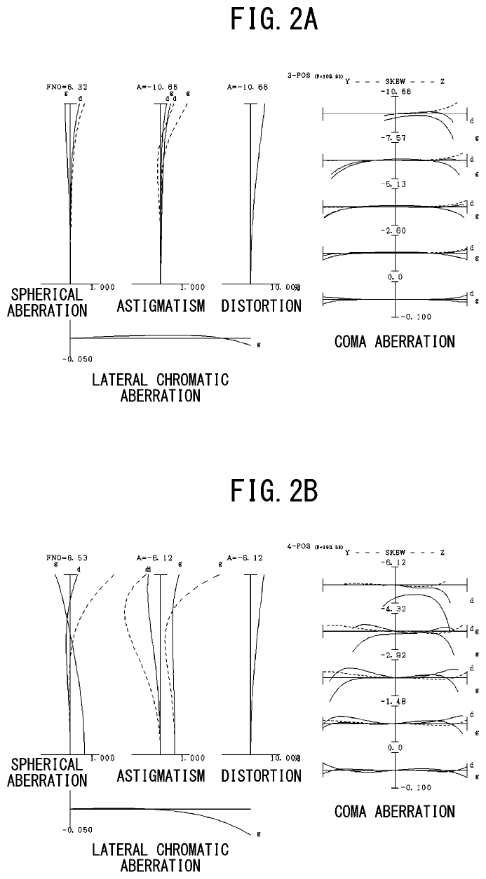

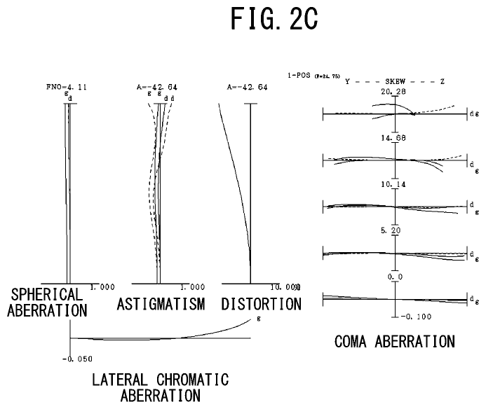

FIG. 2A shows aberrations of the variable magnification optical system of the first example focusing on an object at infinity in the wide-angle end state. FIG. 2B shows aberrations of the variable magnification optical system of the first example focusing on an object at infinity in an intermediate focal length state. FIG. 2C shows aberrations of the variable magnification optical system of the first example focusing on an object at infinity in the telephoto end state.

In the graphs of aberrations, FNO and Y denote f-number and image height, respectively. More specifically, the graphs of spherical aberration show the f-number corresponding to the maximum aperture, the graphs of astigmatism and distortion show the maximum of image height, and the graphs of coma aberration show the values of image height. d and g denote d-line and g-line (wavelength 435.8 nm), respectively. In the graphs of astigmatism, the solid lines and the broken lines show a sagittal plane and a meridional plane, respectively. The reference symbols in the graphs of aberrations of the present example will also be used in those of the other examples described below.

The graphs of aberrations suggest that the variable magnification optical system of the present example effectively reduces variations in aberrations at focusing and at varying magnification and has high optical performance.

### Second Example

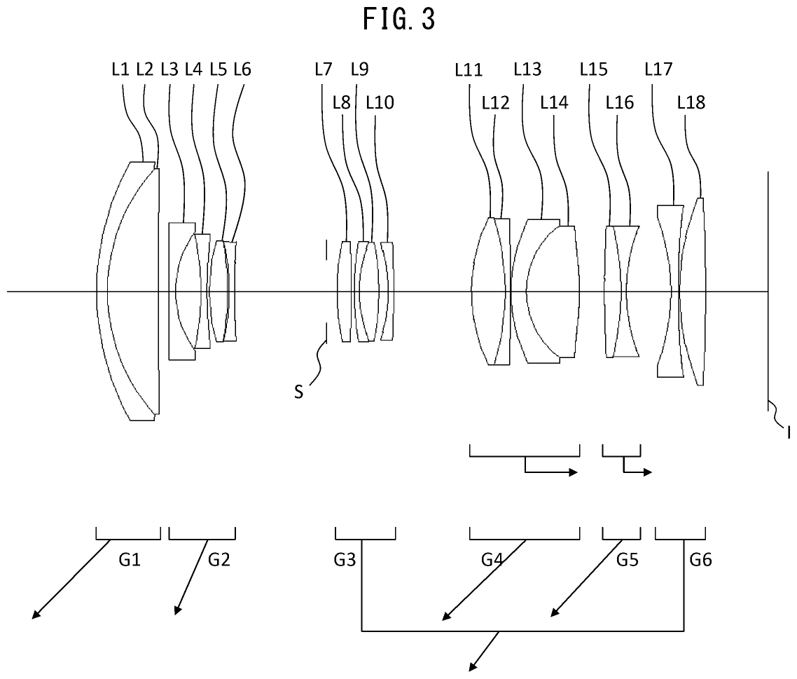

FIG. 3 is a cross-sectional view of a variable magnification optical system of a second example focusing on an object at infinity in the wide-angle end state.

The variable magnification optical system of the present example includes, in order from the object side, a first lens group G1 having positive refractive power, a second lens group G2 having negative refractive power, an aperture stop S, a third lens group G3 having positive refractive power, a fourth lens group G4 having positive refractive power, a fifth lens group G5 having negative refractive power, and a sixth lens group G6 having negative refractive power.

The first lens group G1 consists of a positive cemented lens composed of, in order from the object side, a negative meniscus lens L1 convex on the object side and a positive meniscus lens L2 convex on the object side.

The second lens group G2 consists of, in order from the object side, a negative meniscus lens L3 convex on the object side, a biconcave negative lens L4, a biconvex positive lens L5, and a biconcave negative lens L6.

The third lens group G3 consists of, in order from the object side, a biconvex positive lens L7, a positive cemented lens composed of a negative meniscus lens L8 convex on the object side and a biconvex positive lens L9, and a negative meniscus lens L10 concave on the object side.

The fourth lens group G4 consists of, in order from the object side, a positive cemented lens composed of a biconvex positive lens L11 and a negative meniscus lens L12 concave on the object side as well as a positive cemented lens composed of a negative meniscus lens L13 convex on the object side and a biconvex positive lens L14.

The fifth lens group G5 consists of a negative cemented lens composed of, in order from the object side, a biconvex positive lens L15 and a biconcave negative lens L16.

The sixth lens group G6 consists of, in order from the object side, a biconcave negative lens L17 and a biconvex positive lens L18.

An imaging device (not shown) constructed from CCD, CMOS, or the like is disposed on an image plane I.

The variable magnification optical system of the present example focuses by moving the fourth lens group G4 and the fifth lens group G5 along the optical axis. When focus is shifted from infinity to a nearby object, the fourth lens group G4 and the fifth lens group G5 move from the object side toward the image side.

In the variable magnification optical system of the present example, the second lens group G2, the third lens group G3, the fourth lens group G4, the fifth lens group G5, and the sixth lens group G6 correspond to the rear group, and the sixth lens group G6 to the final lens group. The second lens group G2 corresponds to the first negative lens group, the third lens group G3 to the first positive lens group, the fourth lens group G4 to the second positive lens group, and the fifth lens group G5 to the second negative lens group. The fourth lens group G4 corresponds to the first focusing group and the positive focusing group, and the fifth lens group G5 to the second focusing group and the negative focusing group.

Table 2 below shows specifications of the variable magnification optical system of the present example.

TABLE 2
[General specifications]

| | |
|---|---|
| fw | 24.75 |
| ft | 193.60 |
| Fnow | 4.00 |
| Fnot | 6.50 |

[Lens specifications]

| m | r | d | nd | νd | (19) | (21) |
|---|---|---|---|---|---|---|
| 1) | 50.215 | 2.000 | 1.903660 | 31.27 | | |
| 2) | 34.572 | 9.588 | 1.603000 | 65.44 | | |
| 3) | 1311.519 | d3 | | | | |
| 4) | 734.769 | 1.307 | 1.953750 | 32.33 | | |
| 5) | 18.756 | 4.799 | | | | |
| 6) | −48.834 | 1.129 | 1.755000 | 52.33 | | |
| 7) | 82.569 | 0.451 | | | | |
| 8) | 35.539 | 3.409 | 1.922860 | 20.88 | | |
| 9) | −55.882 | 0.297 | | | | |
| 10) | −40.429 | 1.015 | 1.816000 | 46.59 | | |
| 11) | 149.588 | d11 | | | | |
| 12> | ∞ | 2.016 | (aperture stop) | | | |
| 13) | 45.792 | 2.740 | 1.902650 | 35.72 | P1 | |
| 14) | −158.052 | 0.500 | | | | |
| 15) | 51.626 | 1.000 | 2.001000 | 29.12 | | |
| 16) | 25.348 | 3.645 | 1.579570 | 53.74 | | |
| 17) | −47.120 | 1.756 | | | | |
| 18) | −28.990 | 1.043 | 1.953750 | 32.33 | | |
| 19) | −180.881 | d19 | | | | |
| 20) | 31.325 | 6.348 | 1.834810 | 42.73 | P1 | |
| 21) | −46.677 | 1.000 | 1.903660 | 31.27 | | |
| 22) | −434.420 | 0.175 | | | | |
| 23) | 31.122 | 2.824 | 1.953750 | 32.33 | | |
| 24) | 15.393 | 10.000 | 1.497100 | 81.49 | | P2 |
| *25) | −46.610 | d25 | | | | |
| 26) | 192.398 | 3.146 | 1.846660 | 23.80 | P1 | |
| 27) | −50.784 | 1.017 | 1.851350 | 40.13 | | |
| *28) | 33.031 | d28 | | | | |
| 29) | −39.648 | 1.400 | 1.820800 | 42.51 | | |
| *30) | 237.062 | 0.232 | | | | |
| 31) | 46.735 | 4.880 | 1.683760 | 37.57 | P1 | |
| 32) | −359.761 | Bf | | | | |

[Aspherical surface data]

| m | K | A4 | A6 | A8 | A10 | A12 |
|---|---|---|---|---|---|---|
| 25) | 0.0000 | 3.31E−05 | −5.07E−08 | 7.86E−10 | −4.83E−12 | 1.35E−14 |
| 28) | 0.0000 | −3.68E−06 | 5.73E−08 | −1.75E−10 | −8.02E−13 | 5.32E−15 |
| 30) | 0.0000 | 7.67E−06 | −1.25E−08 | 6.72E−11 | −1.62E−13 | |

[Focal length data of groups]

| Groups | Starting surfaces | Focal lengths |
|---|---|---|
| G1 | 1 | 110.64 |
| G2 | 4 | −16.88 |
| G3 | 13 | 59.63 |
| G4 | 20 | 27.13 |
| G5 | 26 | −47.14 |
| G6 | 29 | −137.34 |

[Variable distance data]

| | Wide-angle end state | Telephoto end state |
|---|---|---|
| d3 | 1.969 | 54.765 |
| d11 | 17.288 | 1.166 |
| d19 | 14.645 | 1.478 |
| d25 | 4.685 | 2.612 |
| d28 | 8.395 | 23.634 |
| Bf | 11.793 | 37.548 |

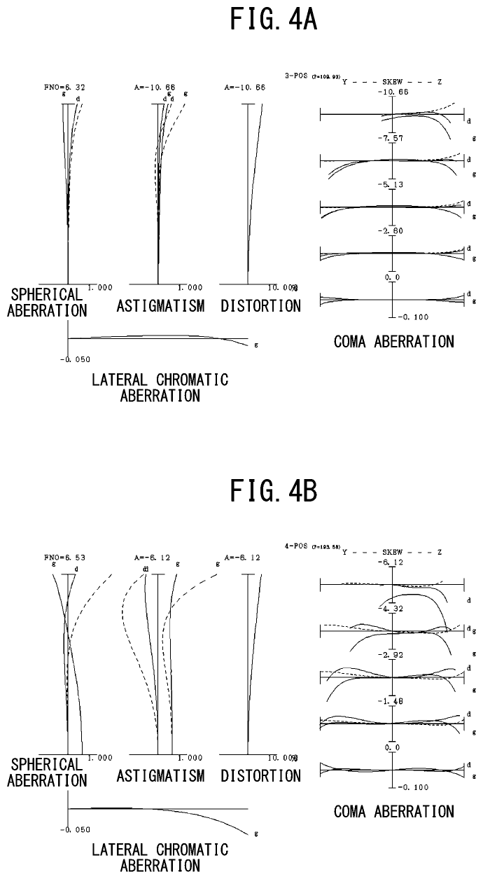

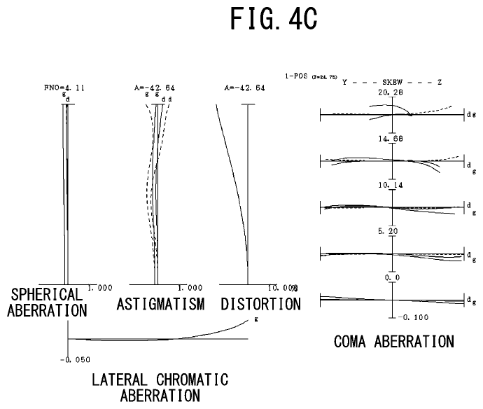

FIG. 4A shows aberrations of the variable magnification optical system of the second example focusing on an object at infinity in the wide-angle end state. FIG. 4B shows aberrations of the variable magnification optical system of the second example focusing on an object at infinity in an intermediate focal length state. FIG. 4C shows aberrations of the variable magnification optical system of the second example focusing on an object at infinity in the telephoto end state.

The graphs of aberrations suggest that the variable magnification optical system of the present example effectively reduces variations in aberrations at focusing and at varying magnification and has high optical performance.

### Third Example

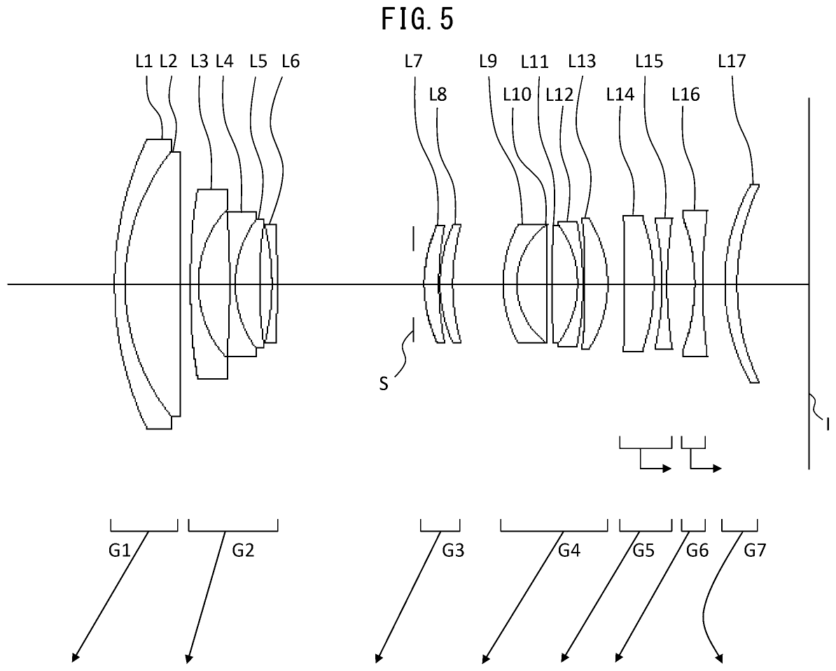

FIG. 5 is a cross-sectional view of a variable magnification optical system of a third example focusing on an object at infinity in the wide-angle end state.

The variable magnification optical system of the present example includes, in order from the object side, a first lens group G1 having positive refractive power, a second lens group G2 having negative refractive power, an aperture stop S, a third lens group G3 having positive refractive power, a fourth lens group G4 having positive refractive power, a fifth lens group G5 having negative refractive power, a sixth lens group G6 having negative refractive power, and a seventh lens group G7 having positive refractive power.

The first lens group G1 consists of a positive cemented lens composed of, in order from the object side, a negative meniscus lens L1 convex on the object side and a positive meniscus lens L2 convex on the object side.

The second lens group G2 consists of, in order from the object side, a negative meniscus lens L3 convex on the object side, a positive cemented lens composed of a biconcave negative lens L4 and a positive meniscus lens L5 convex on the object side, and a negative meniscus lens L6 concave on the object side.

The third lens group G3 consists of, in order from the object side, a positive meniscus lens L7 convex on the object side and a positive meniscus lens L8 convex on the object side.

The fourth lens group G4 consists of, in order from the object side, a positive cemented lens composed of a negative meniscus lens L9 convex on the object side and a positive meniscus lens L10 convex on the object side, a negative cemented lens composed of a biconvex positive lens L11 and a negative meniscus lens L12 concave on the object side, and a biconvex positive lens L13.

The fifth lens group G5 consists of, in order from the object side, a positive meniscus lens L14 concave on the object side and a biconcave negative lens L15.

The sixth lens group G6 consists of a biconcave negative lens L16.

The seventh lens group G7 consists of a positive meniscus lens L17 convex on the object side.

An imaging device (not shown) constructed from CCD, CMOS, or the like is disposed on an image plane I.

The variable magnification optical system of the present example focuses by moving the fifth lens group G5 and the sixth lens group G6 along the optical axis. When focus is shifted from infinity to a nearby object, the fifth lens group G5 and the sixth lens group G6 move from the object side toward the image side.

In the variable magnification optical system of the present example, the second lens group G2, the third lens group G3, the fourth lens group G4, the fifth lens group G5, the sixth lens group G6, and the seventh lens group G7 correspond to the rear group, and the seventh lens group G7 to the final lens group. The second lens group G2 corresponds to the first negative lens group, the third lens group G3 to the first positive lens group, the fourth lens group G4 to the second positive lens group, and the fifth lens group G5 to the second negative lens group. The fifth lens group G5 corresponds to the first focusing group, the sixth lens group G6 to the second focusing group, and the fifth lens group G5 and the sixth lens group G6 to the negative focusing group.

Table 3 below shows specifications of the variable magnification optical system of the present example.

TABLE 3
[General specifications]

| | |
|---|---|
| fw | 28.00 |
| ft | 194.00 |
| Fnow | 4.37 |
| Fnot | 6.57 |

[Lens specifications]

| m | r | d | nd | νd | (19) | (20) | (21) |
|---|---|---|---|---|---|---|---|
| 1) | 63.743 | 2.000 | 1.749500 | 35.25 | | | |
| 2) | 40.141 | 10.350 | 1.593190 | 67.90 | | | |
| 3) | 9735.642 | d3 | | | | | |
| *4) | 158.701 | 1.500 | 1.773870 | 47.25 | | | |
| *5) | 22.089 | 5.915 | | | | | |
| 6) | −167.771 | 1.000 | 1.497820 | 82.57 | | N | |
| 7) | 20.719 | 4.566 | 1.850000 | 27.03 | P1 | | |
| 8) | 79.584 | 2.363 | | | | | |
| 9) | −46.857 | 1.000 | 1.834810 | 42.73 | | | |
| 10) | −393.371 | d10 | | | | | |
| 11> | ∞ | 2.000 | (aperture stop) | | | | |
| *12) | 25.238 | 2.790 | 1.592450 | 66.92 | | | P2 |
| 13) | 59.114 | 0.200 | | | | | |
| 14) | 26.374 | 2.366 | 1.617720 | 49.81 | | | |
| 15) | 38.522 | d15 | | | | | |
| 16) | 23.189 | 2.580 | 1.902650 | 35.77 | | | |
| 17) | 13.857 | 5.703 | 1.497820 | 82.57 | | | P2 |
| 18) | 693.648 | 1.004 | | | | | |
| 19) | 752.104 | 4.789 | 1.517420 | 52.20 | | | |
| 20) | −18.856 | 1.000 | 2.000690 | 25.46 | | | |
| 21) | −60.570 | 0.200 | | | | | |
| *22) | 443.772 | 4.473 | 1.517420 | 52.20 | | | |
| 23) | −23.063 | d23 | | | | | |
| 24) | −308.609 | 5.485 | 1.945944 | 17.98 | | | |
| 25) | −37.228 | 1.504 | | | | | |
| 26) | −58.034 | 1.000 | 1.834000 | 37.18 | | | |
| 27) | 84.476 | d27 | | | | | |
| *28) | −39.484 | 1.500 | 1.773870 | 47.25 | | | |
| 29) | 108.384 | d29 | | | | | |
| 30) | 38.120 | 2.261 | 1.834000 | 37.18 | | | |
| 31) | 43.033 | Bf | | | | | |

[Aspherical surface data]

| m | K | A4 | A6 | A8 | A10 |
|---|---|---|---|---|---|
| 4) | 0.0000 | 7.29E−07 | 2.06E−08 | −4.49E−11 | 2.79E−14 |
| 5) | 0.0000 | 2.28E−06 | 3.23E−08 | 4.83E−11 | 2.02E−13 |
| 12) | 0.0000 | −9.41E−06 | −1.09E−09 | 4.05E−11 | −1.20E−13 |
| 22) | 0.0000 | −3.09E−05 | 2.57E−08 | −7.88E−12 | 3.97E−13 |
| 28) | 0.0000 | −6.15E−06 | −1.61E−08 | 3.82E−11 | −1.85E−14 |

[Focal length data of groups]

| Groups | Starting surfaces | Focal lengths |
|---|---|---|
| G1 | 1 | 127.24 |
| G2 | 4 | −21.51 |
| G3 | 12 | 45.92 |
| G4 | 16 | 42.44 |
| G5 | 24 | −980.13 |
| G6 | 28 | −37.23 |
| G7 | 30 | 331.08 |

[Variable distance data]

| | Wide-angle end state | Telephoto end state |
|---|---|---|
| d3 | 2.000 | 51.261 |
| d10 | 25.674 | 2.000 |
| d15 | 9.525 | 2.000 |
| d23 | 3.205 | 2.269 |
| d27 | 5.176 | 5.639 |
| d29 | 4.174 | 37.020 |
| Bf | 13.579 | 36.718 |

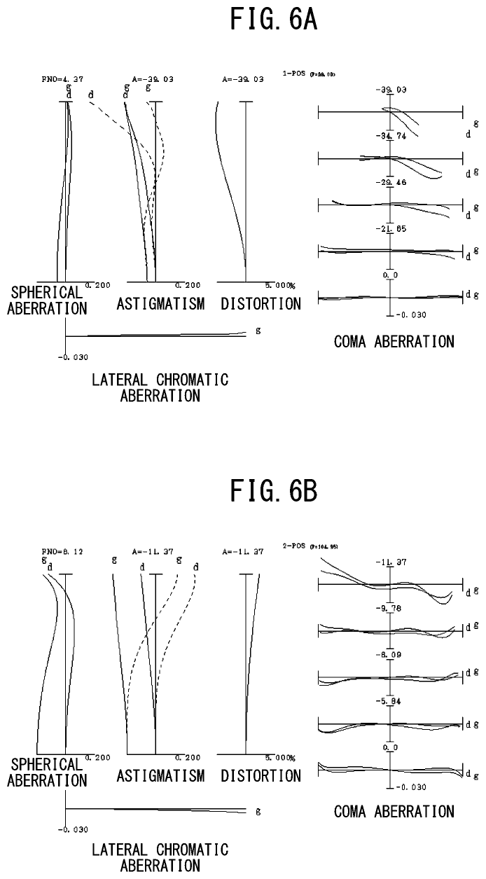

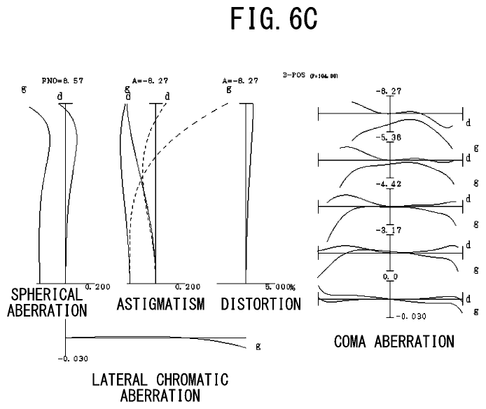

FIG. 6A shows aberrations of the variable magnification optical system of the third example focusing on an object at infinity in the wide-angle end state. FIG. 6B shows aberrations of the variable magnification optical system of the third example focusing on an object at infinity in an intermediate focal length state. FIG. 6C shows aberrations of the variable magnification optical system of the third example focusing on an object at infinity in the telephoto end state.

The graphs of aberrations suggest that the variable magnification optical system of the present example effectively reduces variations in aberrations at focusing and at varying magnification and has high optical performance.

### Fourth Example

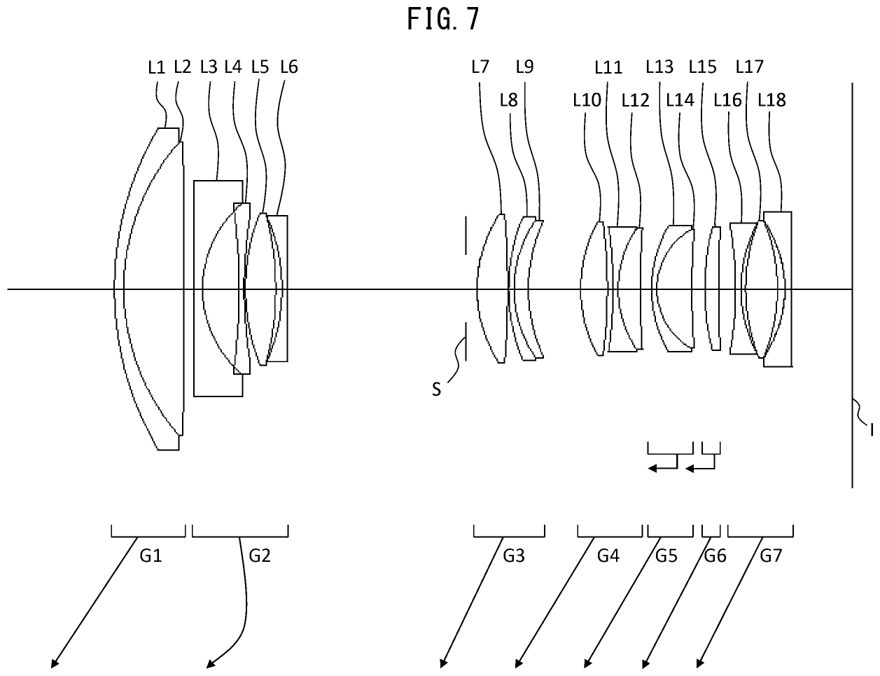

FIG. 7 is a cross-sectional view of a variable magnification optical system of a fourth example focusing on an object at infinity in the wide-angle end state.

The variable magnification optical system of the present example includes, in order from the object side, a first lens group G1 having positive refractive power, a second lens group G2 having negative refractive power, an aperture stop S, a third lens group G3 having positive refractive power, a fourth lens group G4 having negative refractive power, a fifth lens group G5 having positive refractive power, a sixth lens group G6 having positive refractive power, and a seventh lens group G7 having negative refractive power.

The first lens group G1 consists of a positive cemented lens composed of, in order from the object side, a negative meniscus lens L1 convex on the object side and a biconvex positive lens L2.

The second lens group G2 consists of, in order from the object side, a biconcave negative lens L3, a biconcave negative lens L4, a biconvex positive lens L5, and a biconcave negative lens L6.

The third lens group G3 consists of, in order from the object side, a biconvex positive lens L7 and a negative cemented lens composed of a negative meniscus lens L8 convex on the object side and a positive meniscus lens L9 convex on the object side.

The fourth lens group G4 consists of, in order from the object side, a biconvex positive lens L10 and a negative cemented lens composed of a biconcave negative lens L11 and a positive meniscus lens L12 convex on the object side.

The fifth lens group G5 consists of a positive cemented lens composed of, in order from the object side, a negative meniscus lens L13 convex on the object side and a positive meniscus lens L14 convex on the object side.

The sixth lens group G6 consists of a biconvex positive lens L15.

The seventh lens group G7 consists of, in order from the object side, a biconcave negative lens L16, a biconvex positive lens L17, and a planoconcave negative lens L18 concave on the object side.

An imaging device (not shown) constructed from CCD, CMOS, or the like is disposed on an image plane I.

The variable magnification optical system of the present example focuses by moving the fifth lens group G5 and the sixth lens group G6 along the optical axis. When focus is shifted from infinity to a nearby object, the fifth lens group G5 and the sixth lens group G6 move from the image side toward the object side.

In the variable magnification optical system of the present example, the second lens group G2, the third lens group G3, the fourth lens group G4, the fifth lens group G5, the sixth lens group G6, and the seventh lens group G7 correspond to the rear group, and the seventh lens group G7 to the final lens group. The second lens group G2 corresponds to the first negative lens group, the third lens group G3 to the first positive lens group, the fourth lens group G4 to the second negative lens group, and the fifth lens group G5 to the second positive lens group. The fifth lens group G5 corresponds to the first focusing group, the sixth lens group G6 to the second focusing group, and the fifth lens group G5 and the sixth lens group G6 to the positive focusing group.

Table 4 below shows specifications of the variable magnification optical system of the present example.

TABLE 4
[General specifications]

| | |
|---|---|
| fw | 24.70 |
| ft | 233.00 |
| Fnow | 4.50 |
| Fnot | 6.57 |

[Lens specifications]

| m | r | d | nd | νd | (19) | (21) |
|---|---|---|---|---|---|---|
| 1) | 59.540 | 1.800 | 1.902650 | 35.77 | | |
| 2) | 41.859 | 11.321 | 1.593190 | 67.90 | | |
| 3) | −1956.315 | d3 | | | | |
| *4) | −379.614 | 1.500 | 1.773870 | 47.25 | | |
| 5) | 21.088 | 6.883 | | | | |
| 6) | −118.229 | 1.000 | 1.950000 | 29.37 | | |
| 7) | 89.211 | 0.200 | | | | |
| 8) | 38.887 | 5.729 | 1.860740 | 23.08 | P1 | |
| 9) | −55.015 | 1.189 | | | | |
| 10) | −34.049 | 1.000 | 1.816000 | 46.59 | | |
| 11) | 19309.949 | d11 | | | | |
| 12> | ∞ | 2.000 | (aperture stop) | | | |
| *13) | 23.950 | 5.797 | 1.592450 | 66.92 | | P2 |
| 14) | −162.098 | 0.200 | | | | |
| 15) | 35.893 | 1.000 | 1.834810 | 42.73 | | |
| 16) | 22.737 | 2.714 | 1.592700 | 35.27 | P1 | |
| 17) | 30.251 | d17 | | | | |
| 18) | 26.148 | 5.048 | 1.593190 | 67.90 | | P2 |
| 19) | −98.728 | 1.059 | | | | |
| 20) | −84.013 | 1.000 | 2.000690 | 25.46 | | |
| 21) | 20.844 | 4.119 | 1.593190 | 67.90 | | |
| 22) | 163.041 | d22 | | | | |
| 23) | 23.630 | 1.000 | 1.902650 | 35.77 | | |
| 24) | 12.909 | 6.589 | 1.728250 | 28.38 | | |
| 25) | 150.766 | d25 | | | | |
| 26) | 48.329 | 2.746 | 1.548141 | 45.78 | P1 | |
| *27) | −404.148 | d27 | | | | |
| 28) | −65.371 | 1.000 | 1.816000 | 46.59 | | |
| 29) | 26.189 | 0.850 | | | | |
| 30) | 34.959 | 6.023 | 1.688930 | 31.16 | P1 | |
| 31) | −33.122 | 1.371 | | | | |
| *32) | −22.123 | 1.300 | 1.773870 | 47.25 | | |
| 33) | ∞ | Bf | | | | |

[Aspherical surface data]

| m | K | A4 | A6 | A8 | A10 |
|---|---|---|---|---|---|
| 4) | 0.0000 | 2.64E−06 | −1.77E−09 | 5.14E−12 | −3.69E−15 |
| 13) | 0.0000 | −1.00E−05 | −3.09E−09 | −1.67E−11 | −9.99E−15 |
| 27) | 0.0000 | 2.31E−05 | −1.32E−09 | −3.88E−11 | −1.96E−12 |
| 32) | 0.0000 | 6.59E−06 | 1.96E−08 | −1.08E−10 | 5.11E−13 |

[Focal length data of groups]

| Groups | Starting surfaces | Focal lengths |
|---|---|---|
| G1 | 1 | 122.62 |
| G3 | 13 | 41.87 |
| G4 | 18 | −326.91 |
| G5 | 23 | 48.34 |
| G6 | 26 | 78.92 |
| G7 | 28 | −25.48 |

[Variable distance data]

| | Wide-angle end state | Telephoto end state |
|---|---|---|
| d3 | 2.000 | 51.859 |
| d11 | 33.722 | 2.003 |
| d17 | 9.826 | 2.000 |
| d22 | 2.157 | 3.750 |
| d25 | 2.446 | 6.907 |
| d27 | 3.087 | 2.700 |
| Bf | 11.455 | 67.126 |

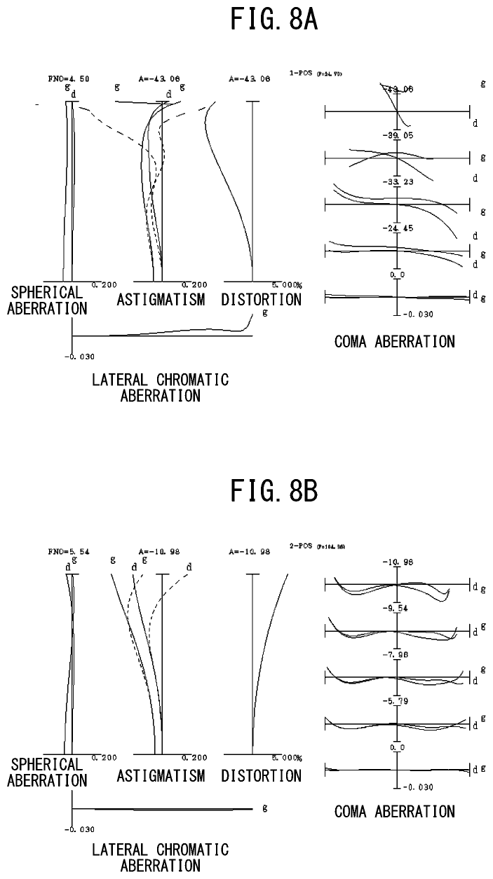

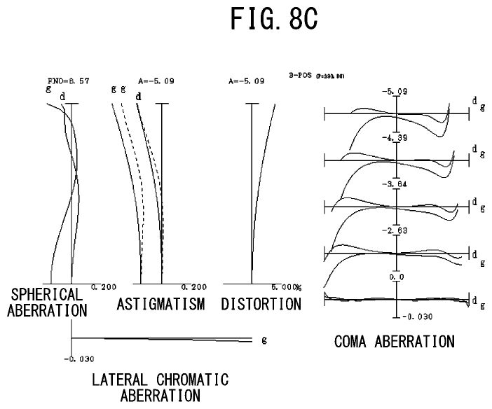

FIG. 8A shows aberrations of the variable magnification optical system of the fourth example focusing on an object at infinity in the wide-angle end state. FIG. 8B shows aberrations of the variable magnification optical system of the fourth example focusing on an object at infinity in an intermediate focal length state. FIG. 8C shows aberrations of the variable magnification optical system of the fourth example focusing on an object at infinity in the telephoto end state.

The graphs of aberrations suggest that the variable magnification optical system of the present example effectively reduces variations in aberrations at focusing and at varying magnification and has high optical performance.

### Fifth Example

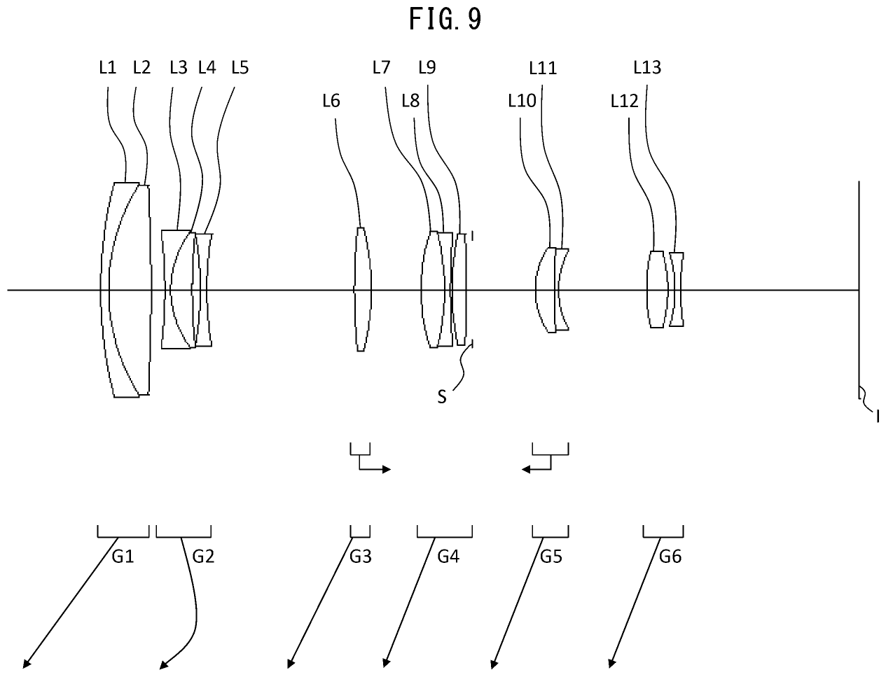

FIG. 9 is a cross-sectional view of a variable magnification optical system of a fifth example focusing on an object at infinity in the wide-angle end state.

The variable magnification optical system of the present example includes, in order from the object side, a first lens group G1 having positive refractive power, a second lens group G2 having negative refractive power, a third lens group G3 having positive refractive power, a fourth lens group G4 having positive refractive power, a fifth lens group G5 having negative refractive power, and a sixth lens group G6 having positive refractive power.

The first lens group G1 consists of a positive cemented lens composed of, in order from the object side, a negative meniscus lens L1 convex on the object side and a biconvex positive lens L2.

The second lens group G2 consists of, in order from the object side, a negative cemented lens composed of a biconcave negative lens L3 and a positive meniscus lens L4 convex on the object side as well as a biconcave negative lens L5.

The third lens group G3 consists of a biconvex positive lens L6.

The fourth lens group G4 consists of, in order from the object side, a positive cemented lens composed of a biconvex positive lens L7 and a biconcave negative lens L8, a biconvex positive lens L9, and an aperture stop S.

The fifth lens group G5 consists of a negative cemented lens composed of, in order from the object side, a positive meniscus lens L10 convex on the object side and a negative meniscus lens L11 convex on the object side.

The sixth lens group G6 consists of, in order from the object side, a biconvex positive lens L12 and a biconcave negative lens L13.

An imaging device (not shown) constructed from CCD, CMOS, or the like is disposed on an image plane I.

The variable magnification optical system of the present example focuses by moving the third lens group G3 and the fifth lens group G5 along the optical axis. When focus is shifted from infinity to a nearby object, the third lens group G3 moves from the object side toward the image side whereas the fifth lens group G5 moves from the image side toward the object side.

In the variable magnification optical system of the present example, the second lens group G2, the third lens group G3, the fourth lens group G4, the fifth lens group G5, and the sixth lens group G6 correspond to the rear group, and the sixth lens group G6 to the final lens group. The second lens group G2 corresponds to the first negative lens group, the third lens group G3 to the first positive lens group, the fourth lens group G4 to the second positive lens group, and the fifth lens group G5 to the second negative lens group. The third lens group G3 corresponds to the first focusing group and the positive focusing group, and the fifth lens group G5 to the second focusing group and the negative focusing group.

Table 5 below shows specifications of the variable magnification optical system of the present example.

TABLE 5
[General specifications]

| | |
|---|---|
| fw | 72.10 |
| ft | 292.00 |
| Fnow | 4.58 |
| Fnot | 6.61 |

[Lens specifications]

| m | r | d | nd | νd | (19) | (21) |
|---|---|---|---|---|---|---|
| 1) | 93.405 | 1.700 | 1.620040 | 36.40 | | |
| 2) | 42.616 | 9.246 | 1.593490 | 67.00 | | |
| 3) | −447.133 | d3 | | | | |
| 4) | −103.511 | 1.300 | 1.683760 | 37.64 | | |
| 5) | 20.714 | 4.645 | 1.846660 | 23.80 | P1 | |
| 6) | 115.440 | 1.781 | | | | |
| 7) | −68.341 | 1.400 | 1.804000 | 46.60 | | |
| 8) | 70.521 | d8 | | | | |
| 9) | 125.904 | 3.704 | 1.593490 | 67.00 | | P2 |
| 10) | −55.136 | d10 | | | | |
| 11) | 40.554 | 5.120 | 1.497820 | 82.57 | | P2 |
| 12) | −50.483 | 1.300 | 1.834000 | 37.18 | | |
| 13) | 158.692 | 0.352 | | | | |
| 14) | 61.264 | 3.021 | 1.516800 | 64.13 | P2 | |
| 15) | −380.539 | 1.336 | | | | |
| 16> | ∞ | d16 | (aperture stop) | | | |
| 17) | 16.841 | 4.019 | 1.516800 | 64.13 | P2 | |
| 18) | 103.211 | 1.000 | 1.834810 | 42.73 | | |
| 19) | 17.184 | d19 | | | | |
| 20) | 36.185 | 4.666 | 1.647690 | 33.72 | P1 | |
| 21) | −30.124 | 1.591 | | | | |
| 22) | −26.250 | 1.200 | 1.772500 | 49.62 | | |
| 23) | 57.120 | Bf | | | | |

[Focal length data of groups]

| Groups | Starting surfaces | Focal lengths |
|---|---|---|
| G1 | 1 | 137.15 |
| G2 | 4 | −33.71 |
| G3 | 9 | 65.10 |
| G4 | 11 | 98.06 |
| G5 | 17 | −97.80 |
| G6 | 20 | 3777.12 |

[Variable distance data]

| | Wide-angle end state | Telephoto end state |
|---|---|---|
| d3 | 3.000 | 57.438 |
| d8 | 32.058 | 2.647 |
| d10 | 10.781 | 15.109 |
| d16 | 13.747 | 14.331 |
| d19 | 19.107 | 19.820 |
| Bf | 38.890 | 67.593 |

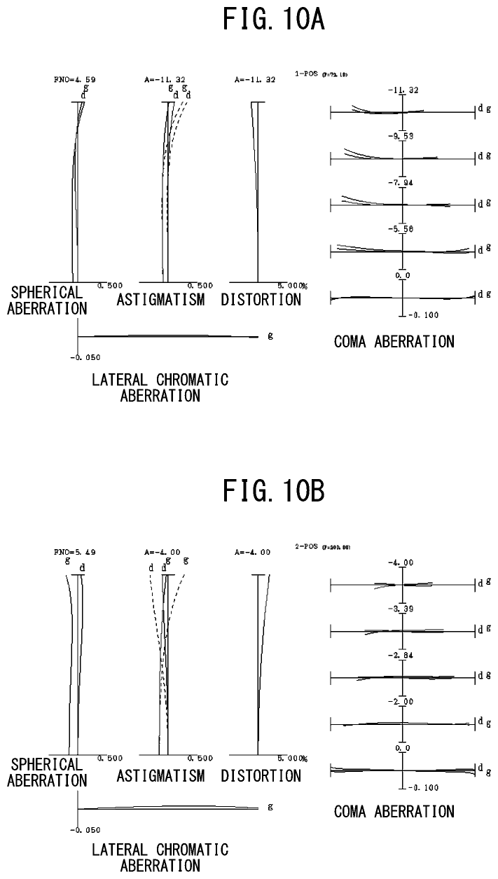

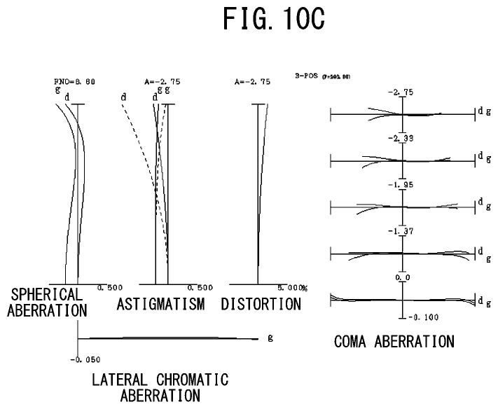

FIG. 10A shows aberrations of the variable magnification optical system of the fifth example focusing on an object at infinity in the wide-angle end state. FIG. 10B shows aberrations of the variable magnification optical system of the fifth example focusing on an object at infinity in an intermediate focal length state. FIG. 10C shows aberrations of the variable magnification optical system of the fifth example focusing on an object at infinity in the telephoto end state.

The graphs of aberrations suggest that the variable magnification optical system of the present example effectively reduces variations in aberrations at focusing and at varying magnification and has high optical performance.

### Sixth Example

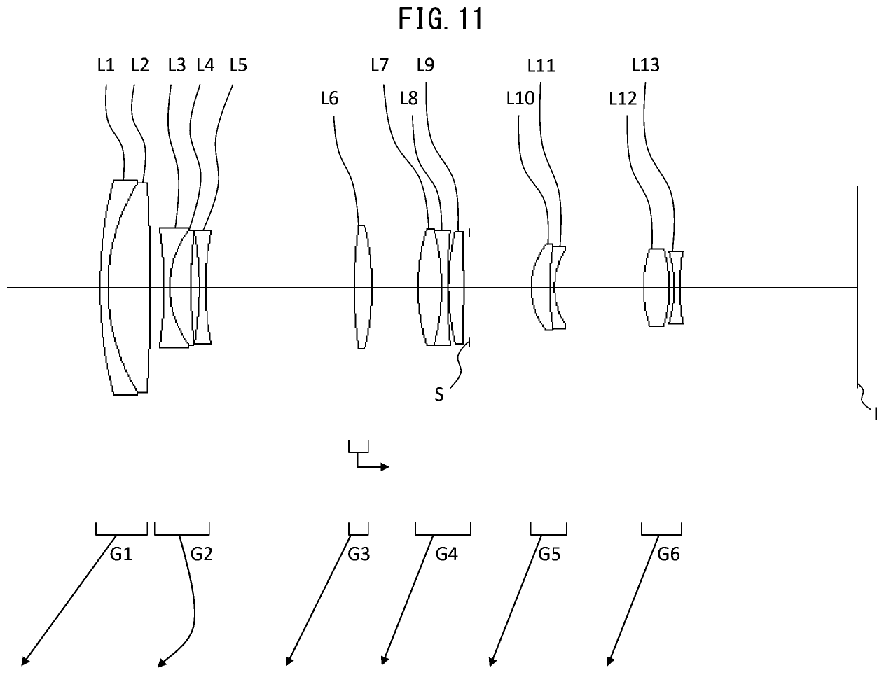

FIG. 11 is a cross-sectional view of a variable magnification optical system of a sixth example focusing on an object at infinity in the wide-angle end state.

The variable magnification optical system of the present example includes, in order from the object side, a first lens group G1 having positive refractive power, a second lens group G2 having negative refractive power, a third lens group G3 having positive refractive power, a fourth lens group G4 having positive refractive power, a fifth lens group G5 having negative refractive power, and a sixth lens group G6 having positive refractive power.

The first lens group G1 consists of a positive cemented lens composed of, in order from the object side, a negative meniscus lens L1 convex on the object side and a biconvex positive lens L2.

The second lens group G2 consists of, in order from the object side, a negative cemented lens composed of a biconcave negative lens L3 and a positive meniscus lens L4 convex on the object side as well as a biconcave negative lens L5.

The third lens group G3 consists of a biconvex positive lens L6.

The fourth lens group G4 consists of, in order from the object side, a negative cemented lens composed of a biconvex positive lens L7 and a biconcave negative lens L8, a biconvex positive lens L9, and an aperture stop S.

The fifth lens group G5 consists of a negative cemented lens composed of, in order from the object side, a positive meniscus lens L10 convex on the object side and a negative meniscus lens L11 convex on the object side.

The sixth lens group G6 consists of, in order from the object side, a biconvex positive lens L12 and a biconcave negative lens L13.

An imaging device (not shown) constructed from CCD, CMOS, or the like is disposed on an image plane I.

The variable magnification optical system of the present example focuses by moving the third lens group G3 along the optical axis. When focus is shifted from infinity to a nearby object, the third lens group G3 moves from the object side toward the image side.

In the variable magnification optical system of the present example, the second lens group G2, the third lens group G3, the fourth lens group G4, the fifth lens group G5, and the sixth lens group G6 correspond to the rear group, and the sixth lens group G6 to the final lens group. The second lens group G2 corresponds to the first negative lens group, the third lens group G3 to the first positive lens group, the fourth lens group G4 to the second positive lens group, and the fifth lens group G5 to the second negative lens group. The third lens group G3 corresponds to the positive focusing group.

Table 6 below shows specifications of the variable magnification optical system of the present example.

TABLE 6
[General specifications]

| | |
|---|---|
| fw | 72.10 |
| ft | 292.00 |
| Fnow | 4.58 |
| Fnot | 6.57 |

[Lens specifications]

| m | r | d | nd | νd | (19) | (21) |
|---|---|---|---|---|---|---|
| 1) | 92.970 | 1.700 | 1.620040 | 36.40 | | |
| 2) | 43.346 | 9.131 | 1.593490 | 67.00 | | |
| 3) | −462.480 | d3 | | | | |
| 4) | −100.059 | 1.300 | 1.683760 | 37.64 | | |
| 5) | 20.916 | 4.670 | 1.846660 | 23.80 | P1 | |
| 6) | 121.589 | 1.756 | | | | |
| 7) | −71.192 | 1.400 | 1.804000 | 46.60 | | |
| 8) | 67.069 | d8 | | | | |
| 9) | 106.891 | 3.779 | 1.593490 | 67.00 | | P2 |
| 10) | −58.234 | d10 | | | | |
| 11) | 43.138 | 5.112 | 1.497820 | 82.57 | | P2 |
| 12) | −47.949 | 1.300 | 1.834000 | 37.18 | | |
| 13) | 142.876 | 0.200 | | | | |
| 14) | 52.297 | 3.255 | 1.516800 | 64.13 | | P2 |
| 15) | −331.307 | 1.309 | | | | |
| 16> | ∞ | d16 | (aperture stop) | | | |
| 17) | 15.447 | 4.036 | 1.487490 | 70.32 | | P2 |
| 18) | 58.875 | 1.000 | 1.816000 | 46.59 | | |
| 19) | 15.196 | d19 | | | | |
| 20) | 27.012 | 5.563 | 1.639800 | 34.55 | P1 | |
| 21) | −31.106 | 1.109 | | | | |
| 22) | −28.302 | 1.200 | 1.816000 | 46.59 | | |
| 23) | 42.508 | Bf | | | | |

[Focal length data of groups]

| Groups | Starting surfaces | Focal lengths |
|---|---|---|
| G1 | 1 | 137.16 |
| G2 | 4 | −33.63 |
| G3 | 9 | 64.06 |
| G4 | 11 | 98.59 |
| G5 | 17 | −88.07 |
| G6 | 20 | 1085.47 |

[Variable distance data]

| | Wide-angle end state | Telephoto end state |
|---|---|---|
| d3 | 3.000 | 57.365 |
| d8 | 32.338 | 2.626 |
| d10 | 10.055 | 15.204 |
| d16 | 13.438 | 16.164 |
| d19 | 19.352 | 24.524 |
| Bf | 38.520 | 60.623 |

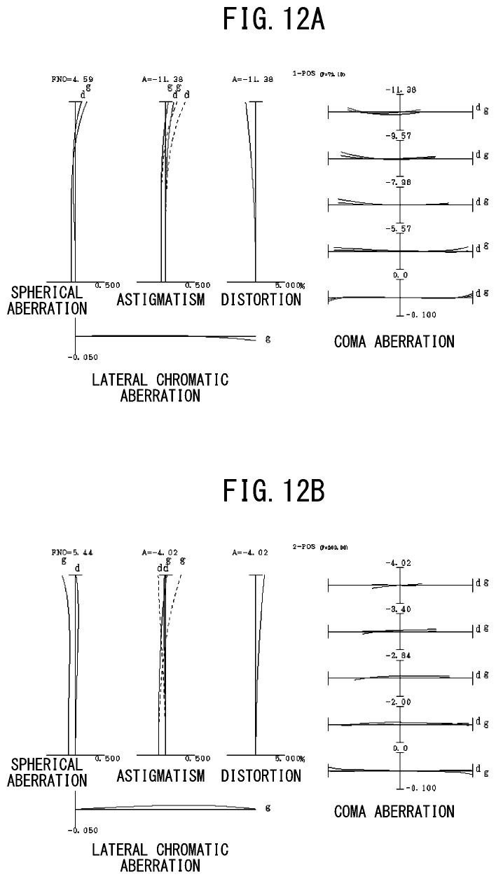

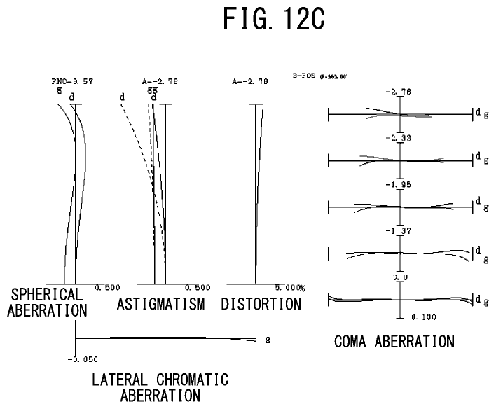

FIG. 12A shows aberrations of the variable magnification optical system of the sixth example focusing on an object at infinity in the wide-angle end state. FIG. 12B shows aberrations of the variable magnification optical system of the sixth example focusing on an object at infinity in an intermediate focal length state. FIG. 12C shows aberrations of the variable magnification optical system of the sixth example focusing on an object at infinity in the telephoto end state.

The graphs of aberrations suggest that the variable magnification optical system of the present example effectively reduces variations in aberrations at focusing and at varying magnification and has high optical performance.

### Seventh Example

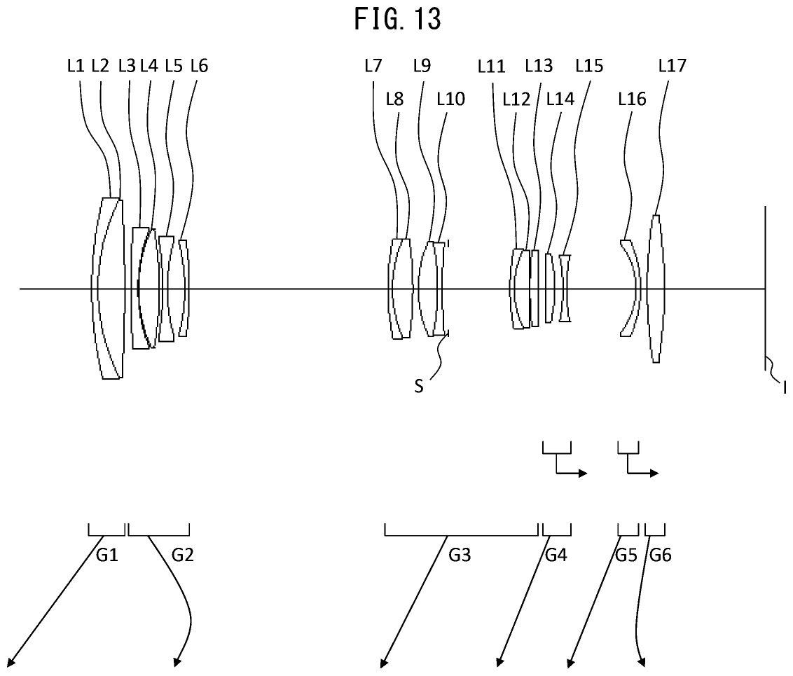

FIG. 13 is a cross-sectional view of a variable magnification optical system of a seventh example focusing on an object at infinity in the wide-angle end state.

The variable magnification optical system of the present example includes, in order from the object side, a first lens group G1 having positive refractive power, a second lens group G2 having negative refractive power, a third lens group G3 having positive refractive power, a fourth lens group G4 having negative refractive power, a fifth lens group G5 having negative refractive power, and a sixth lens group G6 having positive refractive power.

The first lens group G1 consists of a positive cemented lens composed of, in order from the object side, a negative meniscus lens L1 convex on the object side and a biconvex positive lens L2.

The second lens group G2 consists of, in order from the object side, a negative meniscus lens L3 convex on the object side, a biconvex positive lens L4, a biconcave negative lens L5, and a negative meniscus lens L6 concave on the object side.

The third lens group G3 consists of, in order from the object side, a positive cemented lens composed of a negative meniscus lens L7 convex on the object side and a biconvex positive lens L8, a positive cemented lens composed of a biconvex positive lens L9 and a biconcave negative lens L10, an aperture stop S, a negative cemented lens composed of a negative meniscus lens L11 convex on the object side and a positive meniscus lens L12 convex on the object side, and a biconvex positive lens L13.

The fourth lens group G4 consists of, in order from the object side, a positive meniscus lens L14 concave on the object side and a biconcave negative lens L15.

The fifth lens group G5 consists of a negative meniscus lens L16 concave on the object side.

The sixth lens group G6 consists of a biconvex positive lens L17.

An imaging device (not shown) constructed from CCD, CMOS, or the like is disposed on an image plane I.

The variable magnification optical system of the present example focuses by moving the fourth lens group G4 and the fifth lens group G5 along the optical axis. When focus is shifted from infinity to a nearby object, the fourth lens group G4 and the fifth lens group G5 move from the object side toward the image side.

In the variable magnification optical system of the present example, the second lens group G2, the third lens group G3, the fourth lens group G4, the fifth lens group G5, and the sixth lens group G6 correspond to the rear group, and the sixth lens group G6 to the final lens group. The second lens group G2 corresponds to the first negative lens group, the third lens group G3 to the first positive lens group, the fourth lens group G4 to the second negative lens group, and the sixth lens group G6 to the second positive lens group. The fourth lens group G4 corresponds to the first focusing group, the fifth lens group G5 to the second focusing group, and the fourth lens group G4 and the fifth lens group G5 to the negative focusing group.

Table 7 below shows specifications of the variable magnification optical system of the present example.

TABLE 7
[General specifications]

| | |
|---|---|
| fw | 72.10 |
| ft | 292.00 |
| Fnow | 4.49 |
| Fnot | 6.21 |

[Lens specifications]

| m | r | d | nd | νd | (19) | (21) |
|---|---|---|---|---|---|---|
| 1) | 103.381 | 1.800 | 1.612660 | 44.46 | | |
| 2) | 56.049 | 7.558 | 1.497000 | 81.73 | | |
| 3) | −417.833 | d3 | | | | |
| 4) | 1940.418 | 1.700 | 1.728250 | 28.38 | | |
| 5) | 44.522 | 0.200 | | | | |
| 6) | 40.999 | 5.800 | 1.805180 | 25.45 | P1 | |
| 7) | −98.495 | 0.975 | | | | |
| 8) | −90.753 | 1.300 | 1.719990 | 50.27 | | |
| 9) | 49.210 | 5.010 | | | | |
| 10) | −50.325 | 1.200 | 1.804000 | 46.60 | | |
| 11) | −103.290 | d11 | | | | |
| 12) | 74.439 | 1.200 | 1.801000 | 34.92 | | |
| 13) | 34.335 | 5.843 | 1.640000 | 60.20 | | |
| 14) | −89.952 | 1.500 | | | | |
| 15) | 33.118 | 5.468 | 1.487490 | 70.31 | | |
| 16) | −71.039 | 1.300 | 1.806100 | 40.97 | | |
| 17) | 150.553 | 1.732 | | | | |
| 18> | ∞ | 17.417 | (aperture stop) | | | |
| 19) | 58.020 | 1.200 | 1.834000 | 37.18 | | |
| 20) | 24.956 | 4.220 | 1.516800 | 64.14 | P2 | |
| 21) | 248.482 | 0.200 | | | | |
| 22) | 95.637 | 2.538 | 1.801000 | 34.92 | P1 | |
| 23) | −243.668 | d23 | | | | |
| 24) | −178.276 | 2.420 | 1.805180 | 25.45 | P1 | |
| 25) | −42.169 | 2.338 | | | | |
| 26) | −42.123 | 1.000 | 1.772500 | 49.62 | | |
| 27) | 49.172 | d27 | | | | |
| 28) | −20.209 | 1.300 | 1.806100 | 40.97 | | |
| 29) | −33.231 | d29 | | | | |
| 30) | 133.070 | 4.831 | 1.683760 | 37.64 | P1 | |
| 31) | −133.074 | Bf | | | | |

[Focal length data of groups]

| Groups | Starting surfaces | Focal lengths |
|---|---|---|
| G1 | 1 | 198.62 |
| G2 | 4 | −54.01 |
| G3 | 12 | 42.61 |
| G4 | 24 | −54.29 |
| G5 | 28 | −66.96 |
| G6 | 30 | 98.03 |

[Variable distance data]

| | Wide-angle end state | Telephoto end state |
|---|---|---|
| d3 | 2.000 | 80.188 |
| d11 | 56.188 | 2.000 |
| d23 | 2.073 | 3.714 |
| d27 | 19.599 | 17.958 |
| d29 | 1.892 | 28.542 |
| Bf | 28.519 | 29.869 |

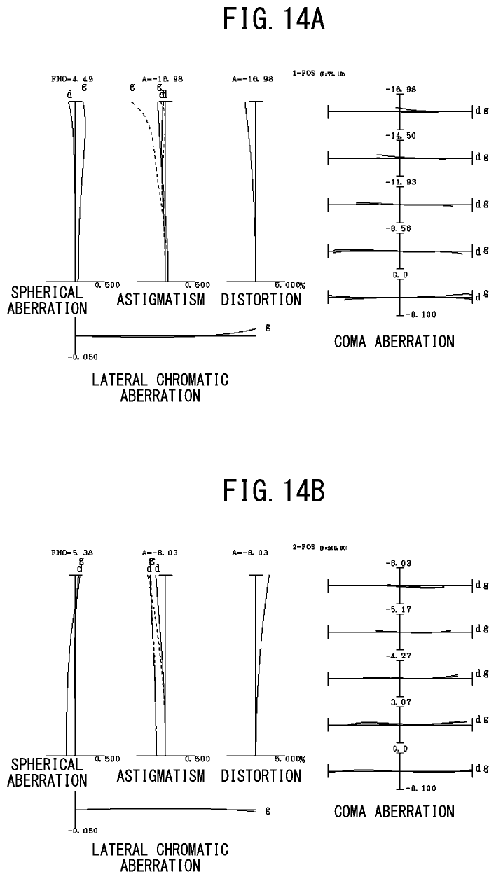

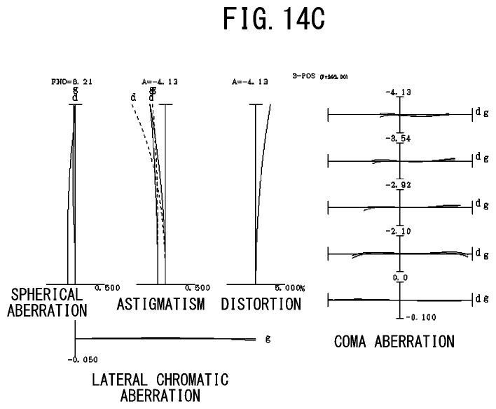

FIG. 14A shows aberrations of the variable magnification optical system of the seventh example focusing on an object at infinity in the wide-angle end state. FIG. 14B shows aberrations of the variable magnification optical system of the seventh example focusing on an object at infinity in an intermediate focal length state. FIG. 14C shows aberrations of the variable magnification optical system of the seventh example focusing on an object at infinity in the telephoto end state.

The graphs of aberrations suggest that the variable magnification optical system of the present example effectively reduces variations in aberrations at focusing and at varying magnification and has high optical performance.

### Eighth Example

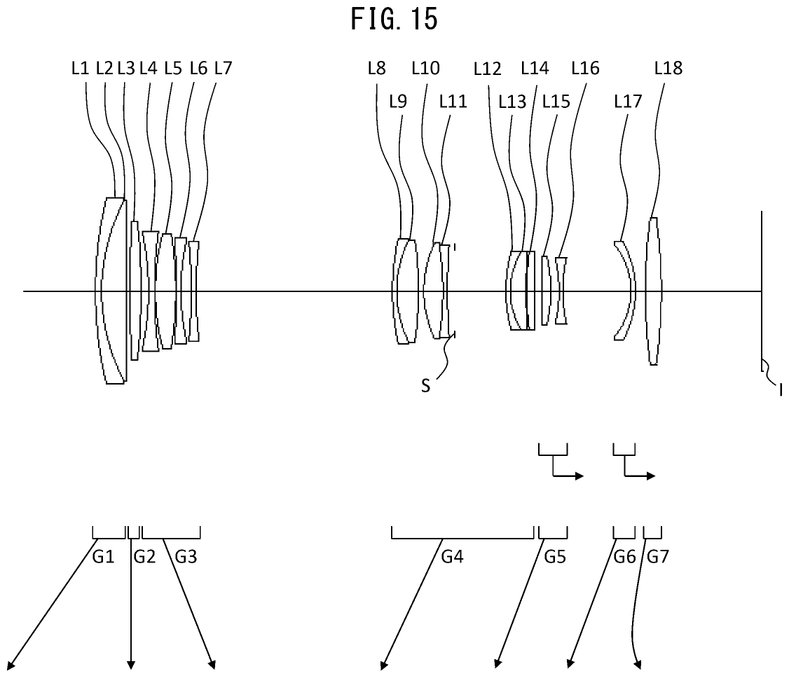

FIG. 15 is a cross-sectional view of a variable magnification optical system of an eighth example focusing on an object at infinity in the wide-angle end state.

The variable magnification optical system of the present example includes, in order from the object side, a first lens group G1 having positive refractive power, a second lens group G2 having positive refractive power, a third lens group G3 having negative refractive power, a fourth lens group G4 having positive refractive power, a fifth lens group G5 having negative refractive power, a sixth lens group G6 having negative refractive power, and a seventh lens group G7 having positive refractive power.

The first lens group G1 consists of a positive cemented lens composed of, in order from the object side, a negative meniscus lens L1 convex on the object side and a biconvex positive lens L2.

The second lens group G2 consists of a biconvex positive lens L3.

The third lens group G3 consists of, in order from the object side, a biconcave negative lens L4, a biconvex positive lens L5, a biconcave negative lens L6, and a biconcave negative lens L7.

The fourth lens group G4 consists of, in order from the object side, a positive cemented lens composed of a negative meniscus lens L8 convex on the object side and a biconvex positive lens L9, a positive cemented lens composed of a biconvex positive lens L10 and a biconcave negative lens L11, an aperture stop S, a positive cemented lens composed of a negative meniscus lens L12 convex on the object side and a positive meniscus lens L13 convex on the object side, and a positive meniscus lens L14 convex on the object side.

The fifth lens group G5 consists of, in order from the object side, a positive meniscus lens L15 concave on the object side and a biconcave negative lens L16.

The sixth lens group G6 consists of a negative meniscus lens L17 concave on the object side.

The seventh lens group G7 consists of a biconvex positive lens L18.

An imaging device (not shown) constructed from CCD, CMOS, or the like is disposed on an image plane I.

The variable magnification optical system of the present example focuses by moving the fifth lens group G5 and the sixth lens group G6 along the optical axis. When focus is shifted from infinity to a nearby object, the fifth lens group G5 and the sixth lens group G6 move from the object side toward the image side.

In the variable magnification optical system of the present example, the second lens group G2, the third lens group G3, the fourth lens group G4, the fifth lens group G5, the sixth lens group G6, and the seventh lens group G7 correspond to the rear group, and the seventh lens group G7 to the final lens group. The second lens group G2 corresponds to the first positive lens group, the third lens group G3 to the first negative lens group, the fourth lens group G4 to the second positive lens group, and the fifth lens group G5 to the second negative lens group. The fifth lens group G5 corresponds to the first focusing group, the sixth lens group G6 to the second focusing group, and the fifth lens group G5 and the sixth lens group G6 to the negative focusing group.

Table 8 below shows specifications of the variable magnification optical system of the present example.

TABLE 8
[General specifications]

| | |
|---|---|
| fw | 72.10 |
| ft | 291.99 |
| Fnow | 4.63 |
| Fnot | 6.45 |

[Lens specifications]

| m | r | d | nd | νd | (19) | (21) |
|---|---|---|---|---|---|---|
| 1) | 50.215 | 2.000 | 1.903660 | 31.27 | | |
| 1) | 110.903 | 1.800 | 1.612660 | 44.46 | | |
| 2) | 54.570 | 6.966 | 1.497000 | 81.73 | | |
| 3) | −8459.724 | d3 | | | | |
| 4) | 389.676 | 3.198 | 1.593490 | 67.00 | | P2 |
| 5) | −170.170 | d5 | | | | |
| 6) | −80.023 | 1.700 | 1.834000 | 37.18 | | |
| 7) | 128.334 | 0.200 | | | | |
| 8) | 62.764 | 5.800 | 1.805180 | 25.45 | P1 | |
| 9) | −104.722 | 0.200 | | | | |
| 10) | −239.601 | 1.300 | 1.593490 | 67.00 | | |
| 11) | 64.821 | 2.975 | | | | |
| 12) | −115.403 | 1.200 | 1.804000 | 46.60 | | |
| 13) | 106.788 | d13 | | | | |
| 14) | 69.826 | 1.200 | 1.801000 | 34.92 | | |
| 15) | 32.742 | 6.159 | 1.640000 | 60.20 | | P2 |
| 16) | −98.985 | 1.500 | | | | |
| 17) | 32.137 | 5.379 | 1.487490 | 70.31 | | P2 |
| 18) | −82.765 | 1.300 | 1.806100 | 40.97 | | |
| 19) | 187.891 | 1.821 | | | | |
| 20> | ∞ | 14.671 | (aperture stop) | | | |
| 21) | 42.155 | 1.200 | 1.834000 | 37.18 | | |
| 22) | 20.994 | 4.480 | 1.516800 | 64.14 | | P2 |
| 23) | 145.744 | 0.200 | | | | |
| 24) | 86.627 | 2.095 | 1.801000 | 34.92 | P1 | |
| 25) | 326.609 | d25 | | | | |
| 26) | −283.549 | 2.410 | 1.805180 | 25.45 | P1 | |
| 27) | −42.139 | 2.354 | | | | |
| 28) | −39.853 | 1.000 | 1.772500 | 49.62 | | |
| 29) | 41.741 | d29 | | | | |
| 30) | −20.381 | 1.300 | 1.806100 | 40.97 | | |
| 31) | −29.284 | d31 | | | | |
| 32) | 146.035 | 4.576 | 1.683760 | 37.64 | | |
| 33) | −146.063 | Bf | | | | |

[Aspherical surface data]

| m | K | A4 | A6 | A8 | A10 | A12 |
|---|---|---|---|---|---|---|
| 25) | 0.0000 | 3.31E−05 | −5.07E−08 | 7.86E−10 | −4.83E−12 | 1.35E−14 |
| 28) | 0.0000 | −3.68E−06 | 5.73E−08 | −1.75E−10 | −8.02E−13 | 5.32E−15 |
| 30) | 0.0000 | 7.67E−06 | −1.25E−08 | 6.72E−11 | −1.62E−13 | |

[Focal length data of groups]

| Groups | Starting surfaces | Focal lengths |
|---|---|---|
| G1 | 1 | 287.74 |
| G2 | 4 | 200.00 |
| G3 | 6 | −42.96 |
| G4 | 14 | 41.02 |
| G5 | 26 | −49.36 |
| G6 | 30 | −88.96 |
| G7 | 32 | 107.48 |

[Variable distance data]

| | Wide-angle end state | Telephoto end state |
|---|---|---|
| d3 | 1.000 | 54.911 |
| d5 | 2.049 | 27.612 |
| d13 | 55.563 | 2.000 |
| d25 | 2.292 | 3.990 |
| d29 | 19.287 | 17.589 |
| d31 | 2.709 | 30.614 |
| Bf | 28.515 | 28.611 |

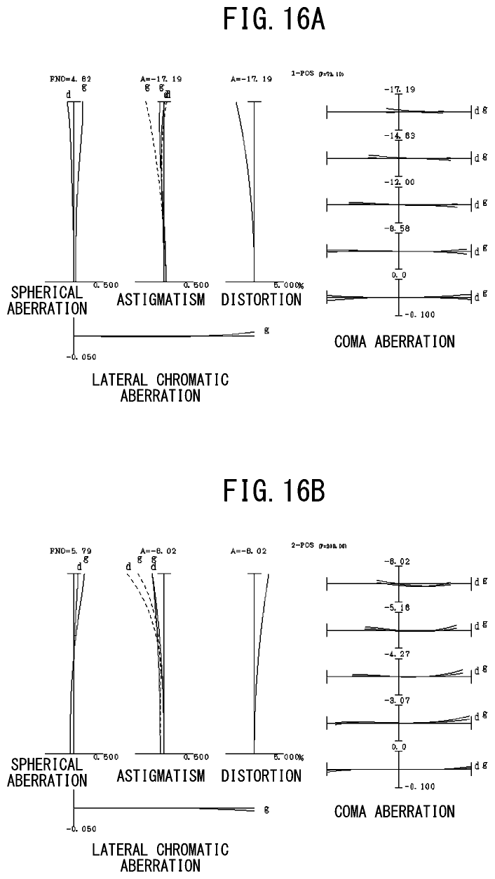

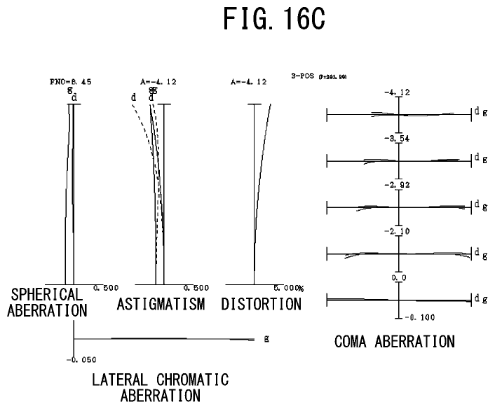

FIG. 16A shows aberrations of the variable magnification optical system of the eighth example focusing on an object at infinity in the wide-angle end state. FIG. 16B shows aberrations of the variable magnification optical system of the eighth example focusing on an object at infinity in an intermediate focal length state. FIG. 16C shows aberrations of the variable magnification optical system of the eighth example focusing on an object at infinity in the telephoto end state.

The graphs of aberrations suggest that the variable magnification optical system of the present example effectively reduces variations in aberrations at focusing and at varying magnification and has high optical performance.

### Ninth Example

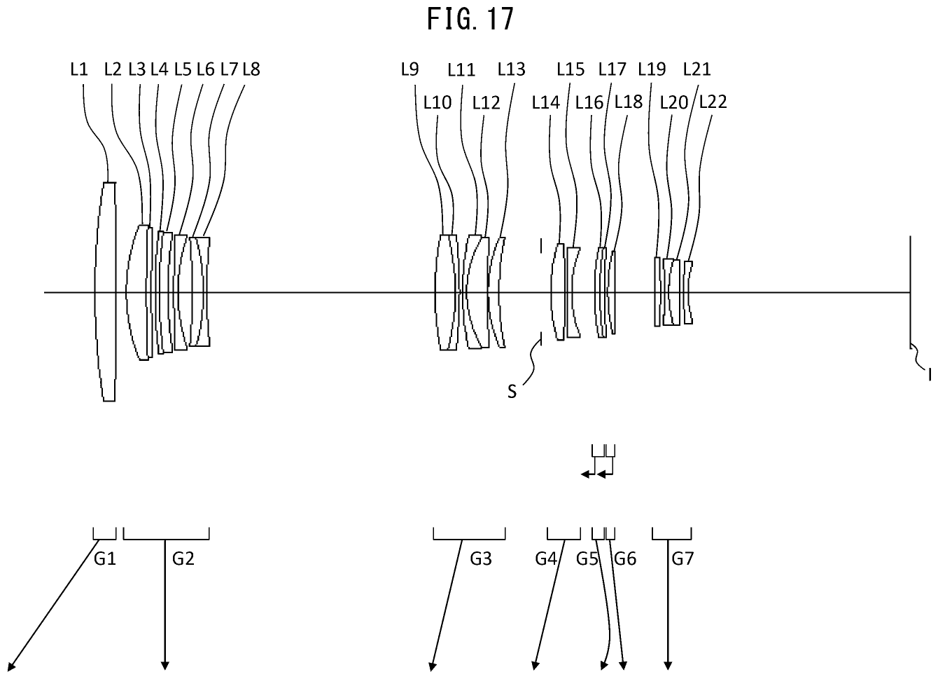

FIG. 17 is a cross-sectional view of a variable magnification optical system of a ninth example focusing on an object at infinity in the wide-angle end state.

The variable magnification optical system of the present example includes, in order from the object side, a first lens group G1 having positive refractive power, a second lens group G2 having negative refractive power, a third lens group G3 having positive refractive power, an aperture stop S, a fourth lens group G4 having negative refractive power, a fifth lens group G5 having positive refractive power, a sixth lens group G6 having positive refractive power, and a seventh lens group G7 having negative refractive power.

The first lens group G1 consists of a biconvex positive lens L1.

The second lens group G2 consists of, in order from the object side, a positive cemented lens composed of a positive meniscus lens L2 convex on the object side and a positive meniscus lens L3 convex on the object side, a negative cemented lens composed of a negative meniscus lens L4 convex on the object side and a negative meniscus lens L5 convex on the object side, a negative meniscus lens L6 convex on the object side, and a negative cemented lens composed of a positive meniscus lens L7 concave on the object side and a biconcave negative lens L8.

The third lens group G3 consists of, in order from the object side, a positive cemented lens composed of a biconvex positive lens L9 and a negative meniscus lens L10 concave on the object side, a negative cemented lens composed of a negative meniscus lens L11 convex on the object side and a positive meniscus lens L12 convex on the object side, and a positive meniscus lens L13 convex on the object side.

The fourth lens group G4 consists of, in order from the object side, a biconvex positive lens L14 and a negative meniscus lens L15 convex on the object side.

The fifth lens group G5 consists of a positive cemented lens composed of, in order from the object side, a positive meniscus lens L16 convex on the object side and a positive meniscus lens L17 convex on the object side.

The sixth lens group G6 consists of a positive meniscus lens L18 convex on the object side.

The seventh lens group G7 consists of, in order from the object side, a biconvex positive lens L19, a negative cemented lens composed of a biconcave negative lens L20 and a biconvex positive lens L21, and a negative meniscus lens L22 convex on the object side.

An imaging device (not shown) constructed from CCD, CMOS, or the like is disposed on an image plane I.

The variable magnification optical system of the present example focuses by moving the fifth lens group G5 and the sixth lens group G6 along the optical axis. When focus is shifted from infinity to a nearby object, the fifth lens group G5 and the sixth lens group G6 move from the image side toward the object side.

In the variable magnification optical system of the present example, the second lens group G2, the third lens group G3, the fourth lens group G4, the fifth lens group G5, the sixth lens group G6, and the seventh lens group G7 correspond to the rear group, and the seventh lens group G7 to the final lens group. The second lens group G2 corresponds to the first negative lens group, the third lens group G3 to the first positive lens group, the fourth lens group G4 to the second negative lens group, and the fifth lens group G5 to the second positive lens group. The fifth lens group G5 corresponds to the first focusing group, the sixth lens group G6 to the second focusing group, and the fifth lens group G5 and the sixth lens group G6 to the positive focusing group.

Table 9 below shows specifications of the variable magnification optical system of the present example.

TABLE 9
[General specifications]

| | |
|---|---|
| fw | 205.00 |
| ft | 683.00 |
| Fnow | 6.30 |
| Fnot | 8.00 |

[Lens specifications]

| m | r | d | nd | νd | (19) | (21) |
|---|---|---|---|---|---|---|
| 1) | 282.304 | 8.619 | 1.518600 | 69.89 | | |
| 2) | −1633.247 | d2 | | | | |
| 3) | 71.894 | 8.200 | 1.688930 | 31.16 | P1 | |
| 4) | 713.201 | 2.000 | 1.719990 | 50.27 | | |
| 5) | 1550.228 | 1.500 | | | | |
| 6) | 218.910 | 1.700 | 1.801000 | 34.92 | | |
| 7) | 194.026 | 3.400 | 1.805180 | 25.45 | | |
| 8) | 153.211 | 2.400 | | | | |
| 9) | 647.598 | 1.700 | 1.762000 | 40.11 | | |
| 10) | 71.876 | 5.689 | | | | |
| 11) | −272.927 | 4.600 | 1.603420 | 38.03 | P1 | |
| 12) | −79.620 | 1.400 | 1.744000 | 44.81 | | |
| 13) | 200.459 | d13 | | | | |
| 14) | 123.134 | 8.211 | 1.593190 | 67.90 | | P2 |
| 15) | −90.441 | 1.700 | 1.902650 | 35.77 | | |
| 16) | −200.512 | 1.200 | | | | |
| 17) | 105.179 | 1.700 | 1.953750 | 32.33 | | |
| 18) | 43.357 | 8.307 | 1.497820 | 82.57 | | P2 |
| 19) | 322.659 | 0.300 | | | | |
| 20) | 54.955 | 4.500 | 1.744000 | 44.81 | P1 | |
| 21) | 110.542 | d21 | | | | |
| 22> | ∞ | 4.000 | (aperture stop) | | | |
| 23) | 70.798 | 5.930 | 1.625880 | 35.72 | P1 | |
| 24) | −204.931 | 0.795 | | | | |
| 25) | 23072.958 | 1.700 | 1.883000 | 40.66 | | |
| 26) | 46.606 | d26 | | | | |
| 27) | 90.300 | 2.279 | 1.677900 | 50.67 | | |
| 28) | 118.675 | 1.711 | 1.850260 | 32.35 | P1 | |
| 29) | 166.913 | d29 | | | | |
| 30) | 75.383 | 2.670 | 1.738000 | 32.26 | | |
| 31) | 705.367 | d31 | | | | |
| 32) | 607.612 | 2.517 | 1.582670 | 46.48 | | |
| 33) | −162.694 | 1.703 | | | | |
| 34) | −168.514 | 1.700 | 1.696800 | 55.52 | | |
| 35) | 48.407 | 4.347 | 1.688930 | 31.16 | P1 | |
| 36) | −1458.581 | 1.700 | | | | |
| 37) | 473.287 | 1.700 | 1.883000 | 40.66 | | |
| 38) | 41.575 | Bf | | | | |

[Focal length data of groups]

| Groups | Starting surfaces | Focal lengths |
|---|---|---|
| G1 | 1 | 464.85 |
| G2 | 3 | −144.07 |
| G3 | 14 | 102.52 |
| G4 | 23 | −163.34 |
| G5 | 27 | 253.50 |
| G6 | 30 | 114.16 |
| G7 | 32 | −54.49 |

[Variable distance data]

| | Wide-angle end state | Telephoto end state |
|---|---|---|
| d2 | 4.000 | 174.000 |
| d13 | 92.124 | 3.000 |
| d21 | 16.841 | 12.922 |
| d26 | 9.152 | 107.086 |
| d29 | 1.500 | 9.376 |
| d31 | 16.068 | 3.300 |
| Bf | 89.891 | 89.891 |

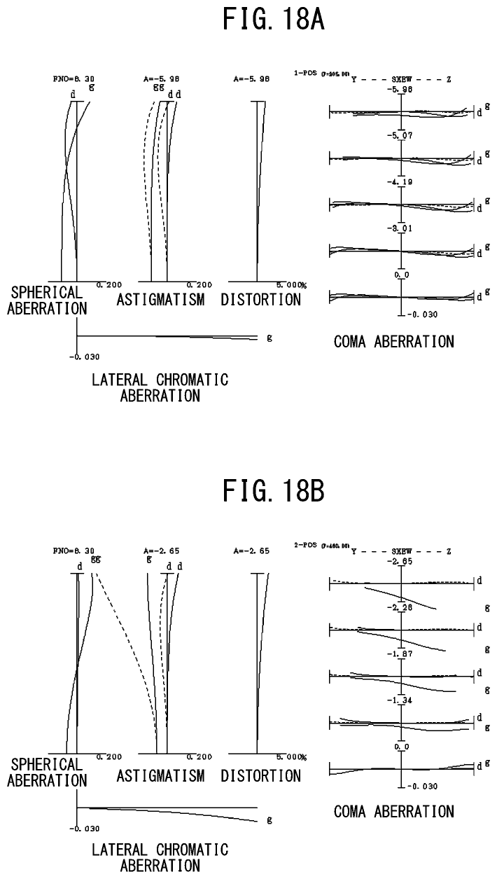

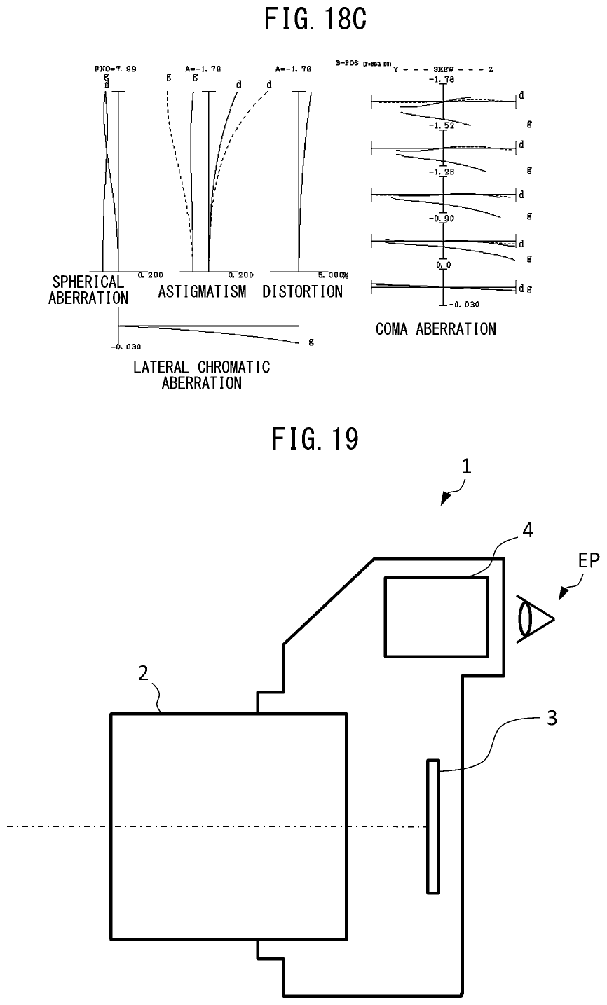

FIG. 18A shows aberrations of the variable magnification optical system of the ninth example focusing on an object at infinity in the wide-angle end state. FIG. 18B shows aberrations of the variable magnification optical system of the ninth example focusing on an object at infinity in an intermediate focal length state. FIG. 18C shows aberrations of the variable magnification optical system of the ninth example focusing on an object at infinity in the telephoto end state.

The graphs of aberrations suggest that the variable magnification optical system of the present example effectively reduces variations in aberrations at focusing and at varying magnification and has high optical performance.

A variable magnification optical system of favorable optical performance can be achieved according to the above examples.

Values for the conditional expressions of the examples are listed below.

f1 is the focal length of the first lens group, D1 is the thickness of the first lens group on an optical axis, and M1 is the amount of movement of the first lens group at varying magnification from a wide-angle end state to a telephoto end state. fN1, fN2, fP1, and fP2 are the focal lengths of the first negative lens group, the second negative lens group, the first positive lens group, and the second positive lens group, respectively. fFP is the focal length of the positive focusing group, and fRPw is a combined focal length in the wide-angle end state of one or more lens groups disposed closer to the image side than the positive focusing group. fFN is the focal length of the negative focusing group, and fRNw is a combined focal length in the wide-angle end state of one or more lens groups disposed closer to the image side than the negative focusing group. fR is the focal length of the final lens group. nd1 is the refractive index for d-line of the lens in the first lens group, and vd1 is the Abbe number for d-line of the lens in the first lens group. Bfw is the back focus of the variable magnification optical system in the wide-angle end state, and fw is the focal length of the variable magnification optical system in the wide-angle end state. fF1 is the focal length of the first focusing group, and fF2 is the focal length of the second focusing group. vdP1 is the Abbe number for d-line of the positive lens in the rear group, vdN is the Abbe number for d-line of the negative lens in the rear group, and vdP2 is the Abbe number for d-line of the positive lens in the rear group.

[Values for conditional expressions]

| Conditional expressions | Examples | 1st | 2nd | 3rd | 4th | 5th |
|---|---|---|---|---|---|---|
| (1) f1/D1: | 9.548 | 9.548 | 10.302 | 9.345 | 12.530 | |
| (2) M1/D1: | 5.387 | 5.387 | 5.957 | 5.461 | 5.423 | |
| (3) f1/(−fN1): | 6.554 | 6.554 | 5.914 | 5.639 | 4.069 | |
| (4) f1/(−fN2): | 2.347 | 2.347 | 0.130 | 0.375 | 1.402 | |
| (5) fN1/fN2: | 0.358 | 0.358 | 0.022 | 0.067 | 0.345 | |
| (6) f1/fP1: | 1.855 | 1.855 | 2.771 | 2.929 | 2.107 | |
| (7) fP1/(−fN1): | 3.532 | 3.532 | 2.134 | 1.926 | 1.931 | |
| (8) fP1/fP2: | 2.198 | 2.198 | 1.082 | 0.866 | 0.664 | |
| (9) f1/fFP: | — | 4.078 | — | 2.537 | 2.107 | |
| | | | | 1.554 | | |
| (10) fFP/fRPw: | — | −0.795 | — | −1.110 | 0.284 | |
| | | | | −3.098 | | |
| (11) f1/(−fFN): | 2.347 | 2.347 | 0.130 | — | 1.402 | |
| (12) (−fFN)/fRNw: | −0.343 | −0.343 | −23.612 | | — | 0.026 |
| (13) f1/(−fR): | 0.806 | 0.806 | — | 4.813 | — | |
| (14) f1/fR: | — | — | 0.384 | — | 0.036 | |
| (15) nd1: | 1.603 | 1.603 | 1.750 | 1.903 | 1.620 | |
| | | | 1.593 | 1.593 | 1.593 | |
| (16) νd1: | 65.44 | 65.44 | 35.25 | 35.77 | 36.40 | |
| | | | 67.90 | 67.90 | 67.00 | |
| (17) Bfw/fw: | 0.476 | 0.476 | 0.485 | 0.464 | 0.539 | |
| (18) \|fF1\|/\|fF2\|: | − | 0.575 | 26.324 | 0.612 | 0.666 | |
| (19) νdP1: | 20.88 | 20.88 | 27.03 | 23.08 | 23.80 | |
| | 35.72 | 35.72 | | 35.27 | 33.72 | |
| | 42.73 | 42.73 | | 45.78 | | |
| | 23.80 | 23.80 | | 31.16 | | |
| | 37.57 | 37.57 | | | | |
| (20) νdN: | — | — | 82.57 | — | — | |
| (21) νdP2: | 81.49 | 81.49 | 66.92 | 66.92 | 67.00 | |
| | | | 82.57 | 67.90 | 82.57 | |
| | | | | | 64.13 | |
| | | | | | 64.13 | |

[Values for conditional expressions]

| Conditional expressions | Examples | 6th | 7th | 8th | 9th |
|---|---|---|---|---|---|
| (1) f1/D1: | 12.664 | 21.226 | 32.826 | 53.933 | |
| (2) M1/D1: | 5.522 | 5.557 | 6.150 | 19.724 | |
| (3) f1/(−fN1): | 4.079 | 3.677 | 6.699 | 3.227 | |
| (4) f1/(−fN2): | 1.557 | 3.659 | 5.830 | 2.846 | |
| (5) fN1/fN2: | 0.382 | 0.995 | 0.870 | 0.882 | |
| (6) f1/fP1: | 2.141 | 4.661 | 1.439 | 4.534 | |
| (7) fP1/(−fN1): | 1.905 | 0.789 | 4.656 | 0.712 | |
| (8) fP1/fP2: | 0.650 | 0.435 | 4.876 | 0.404 | |
| (9) f1/fFP: | 2.141 | — | — | 1.834 | |
| | | | | 4.072 | |
| (10) fFP/fRPw: | 0.244 | — | — | −1.283 | |
| | | | | −2.095 | |
| (11) f1/(−fFN): | — | 3.659 | 5.830 | — | |
| | | 2.966 | 3.235 | | |
| (12) (−fFN)/fRNw: | — | −0.213 | −0.062 | — | |
| | | 0.683 0.828 | | | |
| (13) f1/(−fR): | — | — | — | 8.531 | |
| (14) f1/fR: | 0.126 | 2.026 | 2.677 | — | |
| (15) nd1: | 1.620 | 1.613 | 1.613 | 1.519 | |
| | 1.593 | 1.497 | 1.497 | | |
| (16) νd1: | 36.40 | 44.46 | 44.46 | 69.89 | |
| | 67.00 | 81.73 | 81.73 | | |
| (17) Bfw/fw : | 0.534 | 0.396 | 0.396 | 0.438 | |
| (18) \|fF1\|/\|fF2\|: | — | 0.811 | 0.555 | 2.221 | |
| (19) νdP1: | 23.80 | 25.45 | 25.45 | 31.16 | |
| | 34.55 | 34.92 | 34.92 | 38.03 | |
| | | 25.45 | 25.45 | 44.81 | |
| | | 37.64 | | 35.72 | |
| | | | | 32.35 | |
| | | | | 31.16 | |

| | | | | |
|---|---|---|---|---|
| (20) νdN: | — | — | — | — |
| (21) νdP2: | 67.00 | 64.14 | 67.00 | 67.90 |
| | 82.57 | | 60.20 | 82.57 |
| | 64.13 | | 70.31 | |
| | 70.32 | | 64.14 | |

The above examples are specific examples of the present invention, and the present invention is not limited thereto. The following details can be appropriately employed unless the optical performance of the variable magnification optical system of the embodiment of the present application is compromised.

The lens surfaces of the lenses constituting any of the variable magnification optical systems of the above examples may be covered with antireflection coating having high transmittance in a wide wavelength range. This reduces flares and ghosts and enables achieving optical performance with high contrast.

Next, a camera including the variable magnification optical system of the present embodiment will be described with reference to FIG. 19.

FIG. 19 schematically shows a camera including the variable magnification optical system of the present embodiment.

The camera 1 is a “mirror-less camera” of an interchangeable lens type including the variable magnification optical system according to the first example as an imaging lens 2.

In the camera 1, light from an object (subject) (not shown) is condensed by the imaging lens 2 and reaches an imaging device 3. The imaging device 3 converts the light from the subject to image data. The image data is displayed on an electronic view finder 4. This enables a photographer who positions his/her eye at an eye point EP to observe the subject.

When a release button (not shown) is pressed by the photographer, the image data is stored in a memory (not shown). In this way, the photographer can take a picture of the subject with the camera 1.

The variable magnification optical system of the first example included in the camera 1 as the imaging lens 2 is a variable magnification optical system of favorable optical performance. Thus, the camera 1 can achieve favorable optical performance. A camera configured by including any of the variable magnification optical systems of the second to ninth examples as the imaging lens 2 can have the same effect as the camera 1.

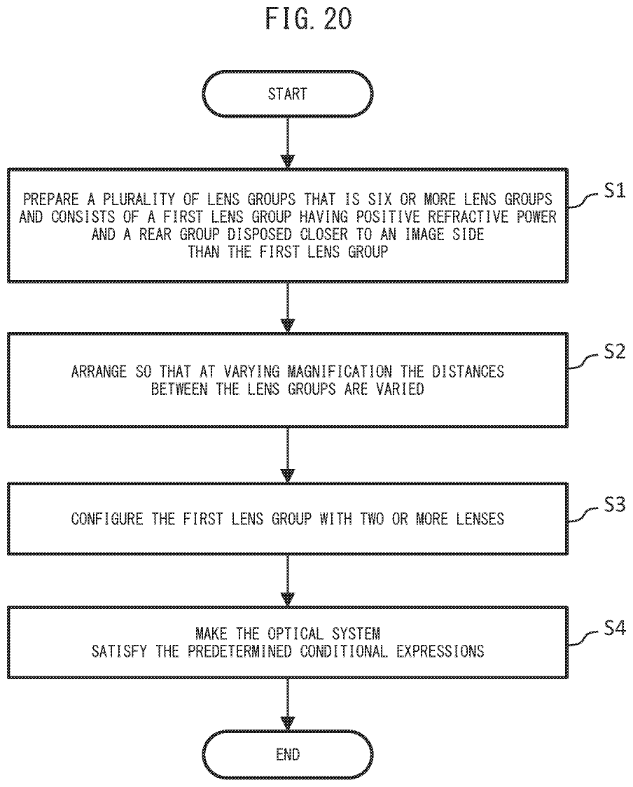

Finally, a method for manufacturing a variable magnification optical system of the present embodiment will be outlined with reference to FIG. 20. FIG. 20 is a flowchart outlining a method for manufacturing a variable magnification optical system of the present embodiment.

The first method for manufacturing a variable magnification optical system of the present embodiment shown in FIG. 20 includes the following steps S1 to S4:

Step S1: preparing a plurality of lens groups that is six or more lens groups and comprises a first lens group having positive refractive power and a rear group disposed closer to an image side than the first lens group;

Step S2: arranging so that at varying magnification the distances between the lens groups are varied;

Step S3: configuring the first lens group with two or fewer lenses; and

Step S4: making the variable magnification optical system satisfy all of the following conditional expressions:

7.50<f1/D1<55.00 (1)

4.00<M1/D1<22.00 (2)

where
f1 is the focal length of the first lens group,
D1 is the thickness of the first lens group on an optical axis, and
M1 is the amount of movement of the first lens group at varying magnification from a wide-angle end state to a telephoto end state.

A variable magnification optical system of favorable imaging performance can be manufactured by the method for manufacturing a variable magnification optical system of the present embodiment.

It should be noted that those skilled in the art can make various changes, substitutions, and modifications without departing from the spirit and scope of the present invention.

### REFERENCE SIGNS LIST

S aperture stop
I image plane
1 camera
2 imaging lens
3 imaging device

1. A variable magnification optical system comprising a plurality of lens groups, the plurality of lens groups being six or more lens groups and comprising a first lens group having positive refractive power and a rear group disposed closer to an image side than the first lens group,
at varying magnification the distances between the lens groups being varied,
the first lens group consisting of two or fewer lenses,
both the following conditional expressions being satisfied:
7.50<f1/D1<55.00
4.00<M1/D1<22.00
where
f1 is the focal length of the first lens group,
D1 is the thickness of the first lens group on an optical axis, and
M1 is the amount of movement of the first lens group at varying magnification from a wide-angle end state to a telephoto end state.

2. The variable magnification optical system according to claim 1, wherein the rear group comprises a first negative lens group having negative refractive power, and
the following conditional expression is satisfied:
2.50<f1/(−fN1)<7.00
where
fN1 is the focal length of the first negative lens group.

3. The variable magnification optical system according to claim 1, wherein the rear group comprises a first negative lens group having negative refractive power, and a second negative lens group having negative refractive power and disposed closer to the image side than the first negative lens group, and
the following expression is satisfied:
0.05<f1/(−fN2)<6.50
where
fN2 is the focal length of the second negative lens group.

4. The variable magnification optical system according to claim 1, wherein the rear group comprises a first negative lens group having negative refractive power, and a second negative lens group having negative refractive power and disposed closer to the image side than the first negative lens group, and
the following expression is satisfied:
0.01<fN1/fN2<1.20
where
fN1 is the focal length of the first negative lens group, and
fN2 is the focal length of the second negative lens group.

5. The variable magnification optical system according to claim 2, wherein the first negative lens group is a lens group disposed closest to an object side of lens groups having negative refractive power in the rear group.

6. The variable magnification optical system according to claim 1, wherein the rear group comprises a first positive lens group having positive refractive power, and
the following conditional expression is satisfied:
1.00<f1/fP1<5.00
where
fP1 is the focal length of the first positive lens group.

7. The variable magnification optical system according to claim 1, wherein the rear group comprises a first positive lens group having positive refractive power, and a first negative lens group having negative refractive power and disposed closer to the image side than the first positive lens group, and
the following conditional expression is satisfied:
0.40<fP1/(−fN1)<5.50
where
fP1 is the focal length of the first positive lens group, and
fN1 is the focal length of the first negative lens group.

8. The variable magnification optical system according to claim 1, wherein the rear group comprises a first positive lens group having positive refractive power, and a second positive lens group having positive refractive power and disposed closer to the image side than the first positive lens group.

9. The variable magnification optical system according to claim 8, wherein the following conditional expression is satisfied:
0.20<fP1/fP2<5.50
where
fP1 is the focal length of the first positive lens group, and
fP2 is the focal length of the second positive lens group.

10. The variable magnification optical system according to claim 6, wherein the first positive lens group is a lens group disposed closest to an object side of lens groups having positive refractive power in the rear group.

11. The variable magnification optical system according to claim 1, wherein the rear group comprises a positive focusing group having positive refractive power and configured to move along the optical axis at focusing, and
the following conditional expression is satisfied:
1.00<f1/fFP<5.00
where
fFP is the focal length of the positive focusing group.

12. The variable magnification optical system according to claim 1, wherein the rear group comprises a positive focusing group having positive refractive power and configured to move along the optical axis at focusing, and
the following conditional expression is satisfied:
−3.50<fFP/fRPw<1.00
where
fFP is the focal length of the positive focusing group, and
fRPw is a combined focal length in the wide-angle end state of one or more lens groups disposed closer to the image side than the positive focusing group.

13. The variable magnification optical system according to claim 1, wherein the rear group comprises a negative focusing group having negative refractive power and configured to move along the optical axis at focusing, and
the following conditional expression is satisfied:
0.05<f1/(−fFN)<6.50
where
fFN is the focal length of the negative focusing group.

14. The variable magnification optical system according to claim 1, wherein the rear group comprises a negative focusing group having negative refractive power and configured to move along the optical axis at focusing, and
the following conditional expression is satisfied:
−35.00<(−fFN)/fRNw<1.50
where
fFN is the focal length of the negative focusing group, and
fRNw is a combined focal length in the wide-angle end state of one or more lens groups disposed closer to the image side than the negative focusing group.

15. The variable magnification optical system according to claim 1, wherein a final lens group disposed closest to the image side of lens groups in the rear group has negative refractive power, and
the following conditional expression is satisfied:
0.50<f1/(−fR)<10.00
where
fR is the focal length of the final lens group.

16. The variable magnification optical system according to claim 1, wherein a final lens group disposed closest to the image side of lens groups in the rear group has positive refractive power, and
the following conditional expression is satisfied:
0.01<f1/fR<3.00
where
fR is the focal length of the final lens group.

17. The variable magnification optical system according to claim 1, wherein the first lens group comprises at least one lens satisfying both the following conditional expressions:
1.45<nd1<2.10
20.00<vd1<3.00
where
nd1 is the refractive index for d-line of the lens in the first lens group, and
vd1 is the Abbe number for d-line of the lens in the first lens group.

18. The variable magnification optical system according to claim 1, wherein the following conditional expression is satisfied:
0.10<Bfw/fw<0.95
where
Bfw is the back focus of the variable magnification optical system in the wide-angle end state, and
fw is the focal length of the variable magnification optical system in the wide-angle end state.

19. The variable magnification optical system according to claim 1, wherein the first lens group moves toward an object side at varying magnification from the wide-angle end state to the telephoto end state.

20. The variable magnification optical system according to claim 1, wherein the first lens group consists of, in order from an object side, a negative lens and a positive lens.

21. The variable magnification optical system according to claim 1, wherein the first lens group consists of a positive lens.

22. The variable magnification optical system according to claim 1, wherein the rear group comprises a first focusing group and a second focusing group that move along the optical axis at focusing.

23. The variable magnification optical system according to claim 22, wherein the following conditional expression is satisfied:
0.20<|fF1|/|fF2|<30.00
where
fF1 is the focal length of the first focusing group, and
fF2 is the focal length of the second focusing group.

24. The variable magnification optical system according to claim 1, wherein at least one positive lens in the rear group satisfies the following first conditional expression for dispersion:
vdP<45.00
where
vdP is the Abbe number for d-line of the positive lens in the rear group.

25. The variable magnification optical system according to claim 24, wherein the positive lens satisfying the first conditional expression for dispersion is included in a negative lens group having negative refractive power of lens groups in the rear group.

26. The variable magnification optical system according to claim 1, wherein at least one negative lens in the rear group satisfies the following second conditional expression for dispersion:
60.00<vdN
where
vdN is the Abbe number for d-line of the negative lens in the rear group.

27. The variable magnification optical system according to claim 26, wherein the negative lens satisfying the second conditional expression for dispersion is included in a final lens group disposed closest to the image side of lens groups in the rear group.

28. The variable magnification optical system according to claim 1, wherein at least one lens group having positive refractive power of lens groups in the rear group comprises a positive lens satisfying the following third conditional expression for dispersion:
60.00<vdP
where vdP is the Abbe number for d-line of the positive lens in the rear group.

29. An optical apparatus comprising the variable magnification optical system according to claim 1.

30. A method for manufacturing a variable magnification optical system comprising a plurality of lens groups, the plurality of lens groups being six or more lens groups and comprising a first lens group having positive refractive power and a rear group disposed closer to an image side than the first lens group, the method comprising arranging so that
at varying magnification the distances between the lens groups are varied,
the first lens group consists of two or fewer lenses, and
both the following conditional expressions are satisfied:
7.50<f1/D1<55.00
4.00<M1/D1<22.00
where
f1 is the focal length of the first lens group,
D1 is the thickness of the first lens group on an optical axis, and
M1 is the amount of movement of the first lens group at varying magnification from a wide-angle end state to a telephoto end state.
